(19) United States
(12) Patent Application Publication
(10) Pub. No.: US 2022/0292357 A1
(43) Pub. Date: Sep. 15, 2022

(54) Neural Network Search Method, Apparatus, And Device

(71) Applicant: HUAWEI TECHNOLOGIES CO., LTD., Shenzhen (CN)

(72) Inventors: Hang XU, Shenzhen (CN); Zewei CHEN, Shenzhen (CN); Zhenguo LI, Hong Kong (CN)

(21) Appl. No.: 17/826,873

(22) Filed: May 27, 2022

Related U.S. Application Data
(63) Continuation of application No. PCT/CN2020/126795, filed on Nov. 5, 2020.

(30) Foreign Application Priority Data
Nov. 30, 2019 (CN) 201911209275.5

(51) Int. Cl. G06N 3/08

(52) U.S. Cl. CPC G06N 3/08

(57) ABSTRACT

A neural network search method, apparatus, and device are provided, and relate to the field of artificial intelligence technologies, and specifically, to the field of automatic machine learning technologies. The method includes: A computing device obtains a dataset and N neural networks (S602), where N is a positive integer; and performs K evolutions on the N neural networks to obtain neural network obtained through the K^{th} evolution, where K is a positive integer (S604). In a process of each evolution, a network structure of a neural network obtained in previous evolution is mutated; and a candidate neural network is selected, based on a partially ordered hypothesis, from networks obtained through mutation.

### CROSS-REFERENCE TO RELATED APPLICATIONS

This application is a continuation of International Application No. PCT/CN2020/126795, filed on Nov. 5, 2020, which claims priority to Chinese Patent Application No. 201911209275.5, filed on Nov. 30, 2019. The disclosures of the aforementioned applications are hereby incorporated by reference in their entireties.

### TECHNICAL FIELD

The present invention relates to the field of machine leaning technologies, and in particular, to a neural network search method, apparatus, and device.

### BACKGROUND

Machine learning is widely applied to various fields. However, building of a machine learning model poses high requirements on a machine learning expert. The machine learning expert needs to manually perform troublesome design and debugging for the model, resulting in high human resource and time costs and prolonging a product iteration period. To facilitate easier application of machine learning, reduce required professional knowledge, and improve model performance, automatic machine learning emerges.

Automatic machine learning (automatic machine learning, AutoML) provides a full set of automatic solutions and methods for all processes of machine learning such as data cleaning, feature engineering, model building, and model training and evaluation, to save human resources and time by using computing power and reduce dependency on machine learning engineers.

Currently, in AutoML, a model search method is usually used in a process of model building and model training and evaluation, to implement automatic optimization of a model structure and a model parameter. In an existing search method, some models are selected from a search space for training, and the trained models are evaluated. Then, structures and parameters of the models are adjusted based on an evaluation result. However, in this method, all the selected models need to be trained and evaluated. This takes a long time, resulting in low efficiency in automatic machine learning.

### SUMMARY

Embodiments of the present invention provide a neural network search method, apparatus, and device, to resolve the technical problem of low efficiency in automatic machine learning.

According to a first aspect, an embodiment of the present invention provides a neural network search method. The method includes: A computing device obtains a dataset and N neural networks, where N is a positive integer; and performs K evolutions on the N neural networks to obtain a neural network obtained through the K^{th} evolution, where K is a positive integer. The i^{th} evolution includes: The computing device mutates a network structure of a neural network obtained through the (i−1)^{th} evolution, to obtain a mutated neural network; selects, from the mutated neural network; a neural network whose network structure is superior to that of the neural network obtained through the (i−1)^{th} evolution, to obtain a candidate neural network; and selects, from a set of the neural network obtained through the (i−1)^{th} evolution and the candidate neural network and based on P evaluation parameters corresponding to each neural network in the set, a neural network obtained through the i^{th} evolution. The P evaluation parameters are for evaluating performance of a neural network obtained after each neural network in the set is trained and tested by using the dataset, i and P are positive integers, and 1≤i≤K.

In the foregoing method, in a process of each evolution, a network search space is pruned by using a partially ordered hypothesis. This excludes a neural network with a poor network structure and reduces models that need to be trained and evaluated, to prevent poor networks from occupying computing resources and consuming time. This improves efficiency in automatic machine learning.

With reference to the first aspect, in a possible implementation, the neural network obtained through the (i−1)^{th} evolution is a CNN, and that the computing device mutates a network structure of a neural network obtained through the (i−1)^{th} evolution may include at least one of the following steps:

swapping locations of two convolutional layers in one or more neural networks of the neural network obtained through the (i−1)^{th} evolution;

doubling a channel quantity of one or more convolutional layers in one or more neural networks of the neural network obtained through the (i−1)^{th} evolution;

doubling a step size of a convolution kernel of one or more convolutional layers in one or more neural networks of the neural network obtained through the (i−1)^{th} evolution;

inserting one or more convolutional layers into one or more neural networks of the neural network obtained through the (i−1)^{th} evolution;

deleting one or more convolutional layers from one or more neural networks of the neural network obtained through the (i−1)^{th} evolution;

inserting one or more pooling layers into one or more neural networks of the neural network obtained through the (i−1)^{th} evolution; or

deleting one or more pooling layers from one or more neural networks of the neural network obtained through the (i−1)^{th} evolution.

By using the foregoing imitation manner, a network structure of a neural network obtained by mutating a neural network has a similar topology structure as a network structure of the neural network before the mutation, so that the partially ordered hypothesis is met. This avoids pruning of a network with a good network structure, improving pruning accuracy.

With reference to the first aspect, in a possible implementation, the neural network obtained through the (i−1)^{th} if evolution is a ResNet, and that the computing device mutates a neural network obtained through the (i−1)^{th} evolution may include at least one of the following steps:

swapping locations of two residual units in one or more neural networks of the neural network obtained through the (i−1)^{th} evolution;

doubling a channel quantity of one or more residual units in one or more neural networks of the neural network obtained through the (i−1)^{th} evolution;

doubling a step size of a convolution kernel of one or more residual units in one or more neural networks of the neural network obtained through the (i−1)^{th} evolution;

inserting one or more residual units into one or more neural networks of the neural network obtained through the (i−1)^{th} evolution; or

deleting one or more residual units from one or more neural networks of the neural network obtained through the (i−1)^{th} evolution.

By using the foregoing network mutation manner, a network structure of a neural network obtained by mutating a neural network has a similar topology structure as a network structure of the neural network before the mutation, so that the partially ordered hypothesis is met. This avoids pruning of a network with a good network structure, improving pruning accuracy.

With reference to the first aspect, in a possible implementation, an implementation in which the computing device selects, from the mutated neural network, a candidate neural network whose network structure is superior to that of the neural network obtained through the)^{th} evolution may be as follows: The computing device selects, from a neural network obtained by mutating a first neural network, a neural network whose network structure is superior to that of the first neural network. The candidate neural network includes the neural network that is of the neural network obtained by mutating the first neural network and whose network structure is superior to that of the first neural network, and the first neural network is any neural network of the neural network obtained through the (i−1)^{th} evolution.

Optionally, when at least one of the following conditions is met, a network structure of the neural network obtained by mutating the first neural network is superior to the network structure of the first neural network:

a channel quantity of the neural network obtained by mutating the first neural network is greater than a channel quantity of the first neural network; or

a quantity of convolutional layers in the neural network obtained by mutating the first neural network is greater than a quantity of convolutional layers in the first neural network.

In the foregoing method, in the manner of pruning a mutated neural network based on a channel quantity and a quantity of convolutional layers in the neural network, only statistics about the channel quantity and the layer quantity of the neural network need to be collected. In this way, pruning efficiency is high, further improving efficiency in automatic machine learning.

With reference to the first aspect, in a possible implementation, an implementation in which the computing device selects, from a set of the neural network obtained through the (i−1)^{th} evolution and the candidate neural network and based on P evaluation parameters corresponding to each neural network in the set, a neural network obtained through the (i−1)^{th} evolution may be as follows: The computing device performs non-dominated sorting on the neural networks in the set based on the P evaluation parameters corresponding to each neural network in the set; and then determines that the neural network obtained through the i^{th} evolution is a neural network that is not dominated in the set. A second neural network and a third neural network are two neural networks in the set. If the second neural network is not inferior to the third neural network in terms of each of the P evaluation parameters, and the second neural network is superior to the third neural network in terms of at least one of the P evaluation parameters, the second neural network dominates the third neural network.

In the foregoing method, in a process of each evolution, a Pareto-optimal network is selected from a set including a neural network obtained through the previous evolution and a candidate neural network obtained by mutating the neural network obtained through the previous evolution, to reduce a quantity of neural networks entering a next evolution. This greatly reduces an amount of computation in the process of each evolution, further improving efficiency in automatic machine learning.

With reference to the first aspect, in a possible implementation, an implementation in which the computing device obtains N neural networks may be as follows: The computing device randomly generates M neural networks, where M is a positive integer; trains and tests each of the M neural networks by using the dataset, to obtain P evaluation parameters corresponding to each of the M neural networks; and then selects N neural networks from the M neural networks based on the P evaluation parameters corresponding to each of the M neural networks, where N is not greater than M.

With reference to the first aspect, in a possible implementation, the P evaluation parameters include at least one of a running time, accuracy, and a parameter quantity.

By using the foregoing method, a case in which one evaluation parameter is good but other evaluation parameters are poor in the neural network obtained through the K^{th} evolution can be avoided. In this way, multi-objective optimization is achieved, and a neural network in which P evaluation parameters are balanced is obtained.

According to a second aspect, an embodiment of this application further provides an object recognition method, including: User equipment or a client device obtains a to-be-recognized image, and inputs the to-be-recognized image to an object recognition neural network, to obtain an object type corresponding to the to-be-recognized image.

The object recognition neural network is a network determined from a search space by using the neural network search method according to any one of the first aspect or the implementations of the first aspect, and the search space is built by using a basic unit and a parameter of the basic unit.

Optionally, the to-be-recognized image is an image of an ambient environment of a vehicle and is for recognizing an object in the ambient environment of the vehicle.

Optionally, the parameter of the basic unit includes at least one of a type, a channel quantity parameter, and a size parameter of the basic unit.

Optionally, the basic unit is configured to perform a first operation and a second operation on a feature map input to the basic unit. The feature map is a feature map of the to-be-recognized image, the first operation is for doubling or maintaining a quantity of feature maps input to the basic unit, the second operation is for changing a size of the feature map input to the basic unit from an original first size to a second size or maintain the first size, and the first size is greater than the second size.

Optionally, a neural network in the search space is a ResNet. The basic unit includes a residual module. The residual module is configured to add up the feature map input to the basic unit and a feature map obtained by the basic unit by processing the feature map input to the basic unit.

Optionally, a neural network in the search space is a CNN, and a type of the basic unit includes a convolutional layer and a pooling layer.

In this case, the dataset in the first aspect includes a plurality of samples. Each sample in the dataset includes a sample image and an object type corresponding to the sample image.

According to a third aspect, an embodiment of this application further provides a gesture recognition method, including: User equipment or a client device obtains a to-be-recognized image, and inputs the to-be-recognized image to a gesture recognition neural network, to obtain a gesture type corresponding to the to-be-recognized image.

The gesture recognition neural network is a network determined from a search space by using the neural network search method according to any one of the first aspect or the implementations of the first aspect, and the search space is built by using a basic unit and a parameter of the basic unit.

Optionally, the parameter of the basic unit includes at least one of a type, a channel quantity parameter, and a size parameter of the basic unit.

Optionally, the basic unit is configured to perform a first operation and a second operation on a feature map input to the basic unit. The feature map is a feature map of the to-be-recognized image, the first operation is for doubling or maintaining a quantity of feature maps input to the basic unit, the second operation is for changing a size of the feature map input to the basic unit from an original first size to a second size or maintain the first size, and the first size is greater than the second size.

Optionally, a neural network in the search space is a ResNet. The basic unit includes a residual module. The residual module is configured to add up the feature map input to the basic unit and a feature map obtained by the basic unit by processing the feature map input to the basic unit.

Optionally, a neural network in the search space is a CNN, and a type of the basic unit includes a convolutional layer and a pooling layer.

In this case, the dataset in the first aspect includes a plurality of samples. Each sample in the dataset includes a sample image and a gesture type corresponding to the sample image.

According to a fourth aspect, an embodiment of this application further provides a data prediction method. The method may include: User equipment or a user client obtains to-be-predicted data, and inputs the to-be-predicted data to a target neural network model, to obtain a prediction result corresponding to the to-be-predicted data.

A target neural network may be the neural network obtained through the K^{th} evolution in the first aspect or a neural network of the neural network obtained through the K^{th} evolution, or may be a machine learning model obtained by combining the neural network obtained through the K^{th} evolution and data cleaning and feature engineering algorithms.

Same as that in the second aspect or the third aspect, the target neural network is a network determined from a search space by using the neural network search method according to any one of the first aspect or the implementations of the first aspect, and the search space is built by using a basic unit and a parameter of the basic unit.

According to a fifth aspect, an embodiment of this application further provides a neural network search apparatus, including:

an obtaining module, configured to obtain a dataset and N neural networks, where N is a positive integer; and

an evolution module, configured to perform K evolutions on the N neural networks to obtain a neural network obtained through the K^{th} evolution, where K is a positive integer; and

the evolution module includes a mutation unit, a first selection unit, and a second selection unit, where the mutation unit is configured to: in a process of the evolution, mutate a network structure of a neural network obtained through the (i−1)^{th} evolution, to obtain a mutated neural network, where a neural network obtained through the 0^{th} evolution is the N neural networks;

the first selection unit is configured to: in the process of the evolution, select, from the mutated neural network, a candidate neural network whose network structure is superior to that of the neural network obtained through the (i−1)^{th} evolution, where the candidate neural network is a selected neural network; and the second selection unit is configured to: in the process of the i^{th} evolution, select, from a set of the neural network obtained through the (i−1)^{th} evolution and the candidate neural network and based on P evaluation parameters corresponding to each neural network in the set, a neural network obtained through the i^{th} evolution, where the P evaluation parameters are for evaluating performance of a neural network obtained after each neural network in the set is trained and tested by using the dataset, i is a positive integer not greater than K. and P is a positive integer.

For specific implementation of each unit, refer to the method according to any one of the first aspect or the implementations of the first aspect.

According to a sixth aspect, an embodiment of this application further provides an object recognition apparatus, including functional units for implementing the object recognition method according to the second aspect.

For the units included in the object recognition apparatus and specific implementation of each unit, refer to the method according to any one of the second aspect or the implementations of the second aspect.

According to a seventh aspect, an embodiment of this application further provides a gesture recognition apparatus, including functional units for implementing the gesture recognition method according to the third aspect.

For the units included in the gesture recognition apparatus and specific implementation of each unit, refer to the method according to any one of the third aspect or the implementations of the third aspect.

According to an eighth aspect, an embodiment of this application further provides a data prediction apparatus, including functional units for implementing the gesture recognition method according to the fourth aspect.

For the units included in the data prediction apparatus and specific implementation of each unit, refer to the method according to any one of the fourth aspect or the implementations of the fourth aspect.

According to a ninth aspect, an embodiment of this application further provides a neural network search apparatus, including a processor and a memory. The memory is configured to store a program, the processor executes the program stored in the memory, and when the program stored in the memory is executed, the neural network search apparatus is enabled to implement the method according to any one of the first aspect or the implementations of the first aspect.

According to a tenth aspect, an embodiment of this application further provides an object recognition apparatus, including a processor and a memory. The memory is configured to store a program, the processor executes the program stored in the memory, and when the program stored in the memory is executed, the object recognition apparatus is enabled to implement the method according to any one of the second aspect or the implementations of the second aspect.

According to an eleventh aspect, an embodiment of this application further provides a gesture recognition apparatus, including a processor and a memory. The memory is configured to store a program, the processor executes the program stored in the memory, and when the program stored in the memory is executed, the gesture recognition apparatus is enabled to implement the method according to any one of the third aspect or the implementations of the third aspect.

According to a twelfth aspect, an embodiment of this application further provides a data prediction apparatus, including a processor and a memory. The memory is configured to store a program, the processor executes the program stored in the memory, and when the program stored in the memory is executed, the data prediction apparatus is enabled to implement the method according to any one of the fourth aspect or the implementations of the fourth aspect.

According to a thirteenth aspect, an embodiment of this application further provides a computer program product including instructions. When the computer program product runs on a computer, the computer is enabled to implement the method according to any one of the first aspect or the implementations of the first aspect.

According to a fourteenth aspect, an embodiment of this application further provides a computer-readable storage medium. The computer-readable storage medium stores computer-executable instructions. When being invoked by a computer, the computer-executable instructions are used to enable the computer to implement the method according to any one of the first aspect or the implementations of the first aspect.

According to a fifteenth aspect, an embodiment of this application further provides a computer program product including instructions. When the computer program product runs on a computer, the computer is enabled to implement the method according to any one of the second aspect or the implementations of the second aspect.

According to a sixteenth aspect, an embodiment of this application further provides a computer-readable storage medium. The computer-readable storage medium stores computer-executable instructions. When being invoked by a computer, the computer-executable instructions are used to enable the computer to implement the method according to any one of the second aspect or the implementations of the second aspect.

According to a seventeenth aspect, an embodiment of this application further provides a computer program product including instructions. When the computer program product runs on a computer, the computer is enabled to implement the method according to any one of the third aspect or the implementations of the third aspect.

According to an eighteenth aspect, an embodiment of this application further provides a computer-readable storage medium. The computer-readable storage medium stores computer-executable instructions. When being invoked by a computer, the computer-executable instructions are used to enable the computer to implement the method according to any one of the third aspect or the implementations of the third aspect.

According to a nineteenth aspect, an embodiment of this application further provides a computer program product including instructions. When the computer program product runs on a computer, the computer is enabled to implement the method according to any one of the fourth aspect or the implementations of the fourth aspect.

According to a twentieth aspect, an embodiment of this application further provides a computer-readable storage medium. The computer-readable storage medium stores computer-executable instructions. When being invoked by a computer, the computer-executable instructions are used to enable the computer to implement the method according to any one of the fourth aspect or the implementations of the fourth aspect.

### BRIEF DESCRIPTION OF DRAWINGS

To describe the technical solutions in embodiments of the present invention more clearly, the following briefly describes the accompanying drawings required for describing embodiments. It is clear that the accompanying drawings in the following descriptions show merely some embodiments of the present invention, and a person of ordinary skill in the art may derive other drawings from these accompanying drawings without creative efforts.

FIG. 1 is an architectural diagram of AutoML according to an embodiment of this application;

FIG. 2A is a schematic diagram of an application scenario according to an embodiment of this application;

FIG. 2B is a schematic diagram of another application scenario according to an embodiment of this application;

FIG. 3 is a schematic diagram of an architecture of a system according to an embodiment of this application;

FIG. 4 is a schematic structural diagram of a convolutional neural network according to an embodiment of this application;

FIG. 5 is a schematic diagram of a hardware structure of a chip according to an embodiment of this application;

FIG. 6A is a schematic flowchart of a neural network search method according to an embodiment of this application;

FIG. 6B is a schematic flowchart of an implementation in which a computing device selects, from a set, a neural network obtained through the i^{th} evolution according to an embodiment of this application;

FIG. 7(a) to FIG. 7(f) are schematic diagrams of structures of a ResNet before and after mutation according to an embodiment of this application;

FIG. 8(a) to FIG. 8(f) are schematic diagrams of structures of a CNN before and after mutation according to an embodiment of this application;

FIG. 9A is a schematic flowchart of an object recognition method according to an embodiment of this application;

FIG. 9B is a schematic flowchart of a gesture recognition method according to an embodiment of this application;

FIG. 10A is a schematic illustration of a running time and top-1 accuracy of an obtained model according to an embodiment of this application;

FIG. 10B is a schematic illustration of a parameter quantity and top-1 accuracy of an obtained model according to an embodiment of this application;

FIG. 11 is a schematic diagram of a structure of a neural network search apparatus according to an embodiment of this application;

FIG. 12A is a schematic diagram of a structure of an object recognition apparatus according to an embodiment of this application;

FIG. 12B is a schematic diagram of a structure of a gesture identification apparatus according to an embodiment of this application;

FIG. 13 is a schematic diagram of a structure of another neural network search apparatus according to an embodiment of this application; and

FIG. 14 is a schematic diagram of a structure of an electronic device according to an embodiment of this application.

### DESCRIPTION OF EMBODIMENTS

First, an automatic machine teaming (automatic machine learning, AutoML) architecture in this application is briefly described.

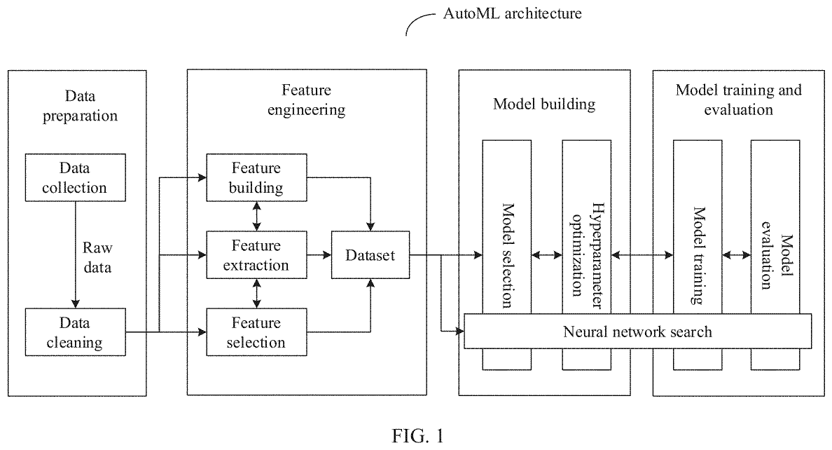

FIG. 1 is a diagram of a system architecture of AutoML according to an embodiment of this application. A main process of AutoML may include the following procedures:

(a) Data Preparation (Data Preparation)

Data preparation may include data collection (data collection) and data cleaning (data cleaning). Data collection includes receiving of raw data sent by user equipment, and may also include collection of data from an existing database, for example, imageNet or Labelme, or obtaining of data in another manner. Data cleaning mainly includes missing value processing, data type determining, abnormal value detection, text encoding, data segmentation, and the like on raw data, to obtain data that can be computed by a machine learning model. The raw data may be an image, voice, text, a video, or a combination thereof, or the like.

(b) Feature Engineering (Feature Engineering)

Feature engineering is a process of using related knowledge in the data field to create a feature that can enable a machine learning algorithm to achieve optimal performance, and is a process of converting raw data into a feature. A purpose of feature engineering is to extract a feature from the raw data to a maximum degree, for use by an algorithm and a model. The process may include feature building, feature extraction, feature selection, and the like. Feature building is to manually build a new feature from the raw data. Feature extraction is to automatically build a new feature and convert a raw feature into a group of features that have obvious physical significance or statistical significance or a core. For example, feature value transformation is performed, to reduce a quantity of values of a feature in the raw data, or the like. Feature selection is to select, from a feature set, a feature subset that has most statistical significance, and delete an irrelevant feature. This achieves a dimension reduction effect. In actual application, feature engineering is an iterative process, in which feature building, feature extraction, feature selection, model selection, model training, and model evaluation need to be performed repeatedly; and then, a final machine learning model can be obtained.

After the raw data undergoes the foregoing feature engineering, a dataset that can be input to a machine learning model can be obtained. It should be understood that the dataset may be classified into a training dataset and a testing dataset. The training dataset is for training a built machine learning model, to obtain a trained machine learning model. The testing dataset is for testing the trained machine learning model, to evaluate performance, for example, accuracy or a running time, of the trained machine learning model.

In some embodiments, feature engineering is not a mandatory process of AutoML. In this case, a dataset can be obtained after the raw data undergoes data cleaning.

(c) Model Building (Model Generation)

After feature engineering, a machine learning model needs to be selected from a machine learning model search space, and a hyperparameter is set for the selected machine learning model. The machine learning model search space includes all possible machine learning models. A machine learning model in the search space may be built in advance or may be built in a search process, which is not limited herein.

(d) Model Training (Model Training) and Model Evaluation (Model Evaluation)

After the machine learning model is selected and the hyperparameter is set for the machine learning model, the initialized machine learning model may be trained by using the training dataset, and a trained machine learning model is evaluated by using the testing dataset. Then, guidance on building, selection, hyperparameter setting, and the like of the machine learning model is provided based on an evaluation result feedback, to finally obtain one or more optimal machine learning models.

(e) Neural Network Search (Neural Architecture Search, NAS)

In embodiments of this application, a machine learning model is a neural network, which may be a deep neural network, for example, a neural network such as a convolutional neural network (convolutional neural network, CNN), a residual neural network (deep residual network, ResNet), or a recurrent neural network. Model search and selection are implemented by using NAS. NAS is an algorithm for searching for an optimal neural network system structure. The method mainly includes automatic optimization of a model structure and a model parameter. In embodiments of this application, when neural network model search and selection are performed by using NAS, an evolution algorithm is used. To be specific, one or more neural networks are built; random mutation is performed on the one or more neural networks, for example, one layer structure is randomly added or deleted, or a channel quantity of one or more layer structures in a neural network is randomly changed; a neural network whose network structure is superior to that of a neural network before the mutation, that is, a candidate neural network, is selected from a mutated neural network based on a partially ordered hypothesis; each of the candidate neural network is trained and tested, to obtain P evaluation parameters corresponding to each neural network; and a neural network with a relatively good evaluation parameter is selected from the candidate neural network based on the P evaluation parameters corresponding to each neural network. Then, processes such as mutation, selection from a mutated neural network, training and testing of a candidate neural network, and selection from the candidate neural network are iteratively performed on the selected neural network, so that a finally selected neural network becomes increasingly better.

It should be noted that in a process of building a machine learning model for a specific task, the foregoing processes usually depend on each other. For example, model selection affects feature transformation used by some features, that is, model selection affects a result of feature transformation.

In embodiments of this application, mainly a neural network search method is described. It should be understood that the method may be combined with other steps or processes, for example, feature engineering and hyperparameter optimization, to obtain an optimal model. For combination with the other steps or processes, refer to related content in an existing technology. Embodiments of this application set no limitation thereto.

The following describes some key terms in embodiments of this application.

(1) Pareto Optimality (Pareto Optimality)

Pareto optimality is an ideal state of resources in which, with a given fixed group of people and given fixed allocatable resources, no individual can be made better off without making at least one worse off during a change from an allocation state to another state. Pareto optimality is also referred to as Pareto improvement. A Pareto optimality state is a state in which no more Pareto improvement can be possibly made. In other words, no one can be made better off without compromising a situation with other people.

For example, evaluation parameters (accuracy, running time (s)) of a given group of models are respectively (0.8, 2), (0.7, 3), (0.9, 2.5), and (0.7, 1). A model with higher accuracy and a lower running time is better. Therefore, it can be seen that a model whose evaluation parameters are (0.8, 2) is superior to a model whose evaluation parameters are (0.7, 3). However, superiority between models whose evaluation parameters are (0.8, 2), (0.9, 2.5), (0.7, 1), and (0.8, 2) cannot be obtained through comparison. In this case, the models whose evaluation parameters are (0.8, 2), (0.9, 2.5), (0.7, 1), and (0.8, 2) are Pareto-optimal models.

(2) Pareto Front

In embodiments of this application, a plurality of evaluation parameters such as accuracy, a running time, and a parameter quantity of models may conflict with each other and cannot be compared in a model optimization process. For example, a model with best accuracy may have a poorest parameter quantity or running time. In a process of improving a model by using NAS, when an evaluation parameter is improved, other evaluation parameters are deteriorated. A set of models with optimal evaluation parameters is a Pareto front. In other words, the Pareto front is a set of Pareto-optimal models.

(3) Non-Dominated Sorting

Non-dominated sorting is a common multi-objective sorting method. It is assumed that an optimization objective is (A, B, C). A point 1 (A₁, B₁, C₁) dominates a point 2 (A₂, B₂, C₂) when and only when A₁≥A₂, B₁≥B₂, C₁≥C₂ and at least one equal sign is false. The point 1 dominating the point 2 means that the point 1 is superior to the point 2. A point that is not dominated by any point is a point on the Pareto front, that is, a non-dominated point.

In embodiments of this application, an optimization objective is P evaluation parameters of models. A model 1 dominates a model 2 when and only when none of P evaluation parameters of the model 1 are inferior to those of the model 2 and at least one of the P evaluation parameters of the model 1 is superior to that of the model 2,

(4) Partially Ordered Hypothesis

The partially ordered hypothesis means that for networks with similar topology structures, a narrower and shallower network is inferior to a deeper and wider network. In other words, a deeper and wider network is superior to a narrower and shallower network. Herein, “wide” and “narrow” both describe a channel quantify of a network, and “deep” and “shallow” both describe a layer quantity of a network.

(5) Partial Order Pruning Algorithm

The partial order pruning algorithm is an algorithm for reducing a model search space by using a principle of the partially ordered hypothesis. In some embodiments of this application, the model search space is reduced by using the principle of the partially ordered hypothesis, to improve model search efficiency.

(6) Dilated Convolution

Dilated convolution is to insert 0s into a center of a common convolution kernel to obtain a larger convolution kernel while maintaining a parameter quantity unchanged, to obtain information in a larger scope.

(7) Depthwise Separable Convolution

In a common convolution process, M feature maps P1 may be converted into N P2s by convoluting the M feature maps by using a common convolution kernel, for example, a high dimensional matrix whose size is (Dₖ, Dₖ, M, N). However, in depthwise separable convolution, M feature maps P1 are first convoluted by using a matrix whose size is (Dₖ, Dₖ, M, 1), to convert the M feature maps P1 into M feature maps P3; and then the M feature maps P3 are convoluted by using a convolution kernel whose size is (1, 1, M, N), to obtain N feature maps P4. The method can greatly reduce a parameter quantity and achieve a good effect.

(8) Neural Network

The neural network may include a neuron. The neuron may be an operation unit that uses xₛ and an intercept of 1 as input. Output of the operation unit may be as follows:

h_{W,b}(x)=f(W^{T}x)=f(Σₛ₌₁ⁿWₛxₛ+b)

Herein, s=1, 2, . . . , or n, n is a natural number greater than 1, Wₛ is a weight of xₛ, and b is a bias of the neuron. f is an activation function (activation functions) of the neuron, and the activation function is used to introduce a non-linear feature into the neural network, to convert an input signal in the neuron into an output signal. The output signal of the activation function may be used as an input for a next convolutional layer. The activation function may be a sigmoid function. The neural network is a network obtained by joining many single neurons together. To be specific, an output of a neuron may be an input for another neuron. Input for each neuron may be connected to a local receptive field of a previous layer to extract a feature of the local receptive field. The local receptive field may be a region including several neurons.

(9) Deep Neural Network

The deep neural network (deep neural network, DNN), also referred to as a multi-layer neural network, may be understood as a neural network having many hidden layers. The “many” herein does not have a special measurement criterion. Based on locations of different layers in the DNN, a neural network in the DNN may be divided into three types: an input layer, a hidden layer, and an output layer. Generally, the first layer is the input layer, the last layer is the output layer, and the middle layer is the hidden layer. Layers are fully connected. To be specific, any neuron in the layer is necessarily connected to any neuron in the (i+1)^{th} layer. Although the DNN looks very complex, work at each layer is actually not complex. In short, the following linear relationship expression applies: y=α(Wx+b), where x is an input vector, y is an output vector, b is an offset vector, W is a weight matrix (also referred to as a coefficient), and α( ) is an activation function. At each layer, the output vector y is obtained only by performing such a simple operation on the input vector x. Because there are many layers in the DNN, there are also many coefficients W and bias vectors b. Definitions of these parameters in the DNN are as follows: The coefficient W is used as an example. It is assumed that in a DNN having three layers, a linear coefficient from the fourth neuron at the second layer to the second neuron at the third layer is defined as W₂₄³. The superscript 3 represents a layer at which the coefficient W is located, and the subscript corresponds to an output third-layer index 2 and an input second-layer index 4. In conclusion, a coefficient from the k^{th} neuron at the (L−1)^{th} layer to the i^{th} neuron at the L^{th} layer is defined as Wⱼₖ^{L}. It should be noted that there is no parameter W at the input layer. In the deep neural network, more hidden layers make the network more capable of describing a complex case in the real world. Theoretically, a model with more parameters has higher complexity and a larger “capacity”. It indicates that the model can complete a more complex learning task. Training the deep neural network is a process of learning a weight matrix, and a final objective of the training is to obtain weight matrices of all layers of a trained deep neural network (weight matrices constituted by vectors W at many layers).

(10) Convolutional Neural Network

The convolutional neural network (CNN, convolutional neuron network) is a deep neural network with a convolutional structure. The convolutional neural network includes a feature extractor constituted by a convolutional layer and a sampling sublayer. The feature extractor may be considered as a filter. A convolution process may be considered as using a trainable filter to perform convolution with an input image or a convolutional feature plane (feature map). The convolutional layer is a neuron layer that performs convolution processing on an input signal that is in the convolutional neural network. In the convolutional layer of the convolutional neural network, one neuron may be connected to only a part of neurons in a neighboring layer. A convolutional layer usually includes several feature planes, and each feature plane may include some neurons arranged in a rectangle. Neurons of a same feature plane share a weight, and the shared weight herein is a convolution kernel. Sharing the weight may be understood as that a manner of extracting image information is unrelated to a position. A principle implied herein is that statistical information of a part of an image is the same as that of another part. This means that image information learned in a part can also be used in the another part. Therefore, image information obtained through same learning can be used for all locations in the image. At a same convolutional layer, a plurality of convolution kernels may be used to extract different image information. Usually, a larger quantity of convolution kernels indicates richer image information reflected by a convolution operation.

The convolution kernel may be initialized in a form of a matrix of a random size. In a training process of the convolutional neural network, an appropriate weight may be obtained for the convolution kernel through learning. In addition, sharing the weight is advantageous because connections between layers of the convolutional neural network are reduced, and a risk of overfilling is reduced.

(11) Deep Residual Network (Deep Residual Network, ResNet)

A depth of a network is of crucial importance to performance of a model. As a layer quantity of a network increases, a more complex feature is extracted from the network, and performance of the network also continuously improves. Therefore, theoretically, a deeper network should have a better effect. However, actually, an excessively deep network encounters a degradation problem due to difficulty in training, and has a worse effect than a relatively shallow network. This is referred to as a degradation problem (degradation problem). This is caused because as a network becomes deeper, training becomes more difficult and network optimization becomes more difficult.

To resolve this problem, a skip connection (also referred to as a shortcut connection) is introduced to the ResNet. The ResNet may include a plurality of cascaded residual units (also referred to as residual blocks) and several fully connected layers. In the ResNet, an output and an input of a residual unit are both input to a next residual unit. For the l^{th} residual unit, xₗ₊₁ f(h(xₗ)+F(xₗ, Wₗ)), where F(xₗ, Wₗ) is an output of the residual unit, xₗ is an input of the l^{th} residual unit, and W is a weight matrix of a plurality of convolutional layers included in the l^{th} residual unit. Each residual unit is activated by using a function f( ).

The following describes application scenarios in embodiments of this application.

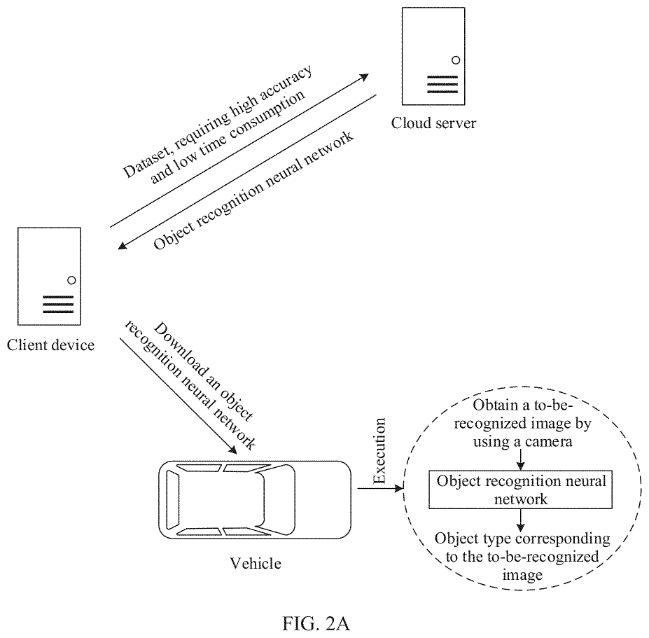

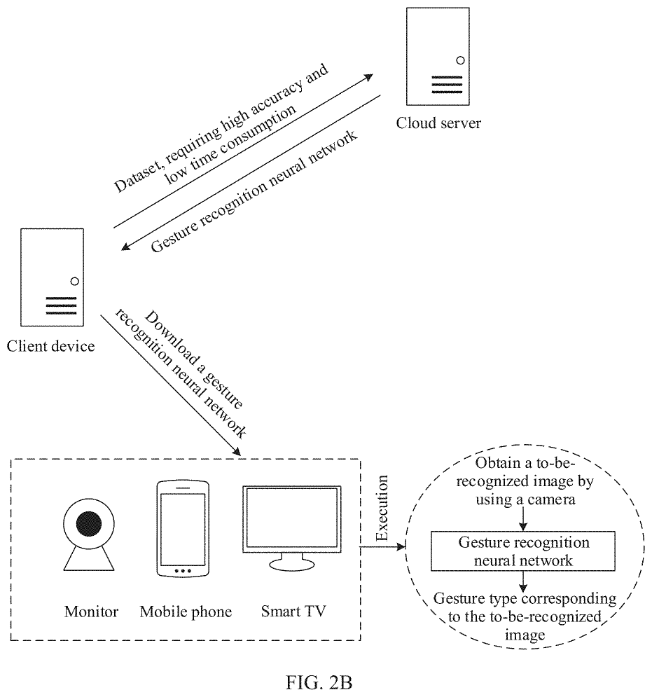

FIG. 2A and FIG. 2B are schematic diagrams of two application scenarios according to embodiments of this application. A client may send raw data or a dataset to a computing device, for example, a cloud server, by using a client device; and request the cloud server to obtain, through training based on the provided raw data or dataset, a target neural network that can complete a specific task. The cloud server may automatically generate, by using powerful computing resources and an AutoML architecture of the cloud server and the raw data or dataset provided by the client, a target neural network that the client needs. The dataset is data obtained after the raw data undergoes data cleaning and feature engineering, and includes a training dataset and a testing dataset. For descriptions of the raw data or the dataset, refer to related descriptions of FIG. 1. Details are not described herein again. The raw data and the dataset may alternatively be data obtained from an existing database, for example, an image obtained from imageNet. The two scenarios provided in embodiments of this application are as follows:

Scenario A:

As shown in FIG. 2A, a client wants a neural network that can recognize an object type. The neural network is applied to a self-driving vehicle or a semi-self-driving vehicle, to recognize an object in a field of view observed by the vehicle by using a camera. The vehicle is in a constant movement process, and safe driving of the vehicle needs to be guaranteed. Therefore, high requirements are posed on real-time performance in object recognition and accuracy of recognizing an object in an ambient environment of the vehicle. In this case, the client may require that the neural network achieve high accuracy and low time consumption in predicting an object type. The client sends a dataset to a cloud server by using a client device, and requests to search for an optimal neural network by using multi-objective optimization (that is, with high accuracy and low time consumption). The dataset includes a plurality of types of sample images. Each sample image is tagged with an object type to which the sample image belongs. Object types may include human, dog, vehicle, traffic light being red, building, traffic line, tree, road edge, and the like.

The cloud server may select a neural network from a neural network search space by using the dataset and an AutoML architecture of the cloud server based on the requirements of the client for high accuracy and low time consumption, and train and evaluate the selected neural network. The cloud server further selects a neural network with high accuracy and low time consumption based on accuracy and time consumption of each trained neural network, and obtains, through a plurality of times of selection, a Pareto-optimal object recognition neural network that the client needs. Then, the cloud server sends the object recognition neural network to the client device. The client device may send the object recognition neural network to the vehicle. Optionally, when the client device is a server, the vehicle may alternatively download the object recognition neural network from the client device.

After receiving the object recognition neural network, the vehicle may perform an object type recognition method. The method may include the following steps: The vehicle obtains a to-be-recognized image by using a camera, where the to-be-recognized image may be an image of an ambient environment of the vehicle; and inputs the to-be-recognized image to the object recognition neural network, to obtain an object type corresponding to the to-be-recognized image. Further, the vehicle may perform a corresponding safe driving method based on the recognized object type in the ambient environment. For example, when recognizing that there is a human in front, the vehicle slows down or brakes, to improve safety of the vehicle during running. For another example, when recognizing that traffic light in front is green light, the vehicle may pass the traffic intersection.

Scenario B:

As shown in FIG. 2B, a client wants a neural network that can recognize a dynamic gesture. The neural network is applied to a terminal, for example, a portable device such as a mobile phone or a tablet computer, a wearable device such as a smart band, a smartwatch, or VR glasses, or a smart household device such as a smart TV, a smart speaker, a smart lamp, or a monitor, to recognize a gesture in a field of view observed by the device by using a camera. A computing capability and storage resources of the terminal are limited. Therefore, a neural network applied to the terminal needs to have high accuracy and a low parameter quantity. The client sends a dataset to a cloud server by using a client device, and requests to search for an optimal neural network by using multi-objective optimization (that is, with high accuracy and a low parameter quantity). The dataset includes sample images of a plurality of gestures, and each sample image is tagged with a gesture type to which the sample image belongs. A gesture type may include a plurality of different gestures.

The cloud server may select a neural network from a neural network search space by using the dataset and an AutoML architecture of the cloud server based on the requirements of the client for high accuracy and low time consumption, and train and evaluate the selected neural network. The cloud server further selects a neural network with high accuracy and low time consumption based on accuracy and time consumption of each trained neural network, and obtains, through a plurality of times of selection, a Pareto-optimal gesture recognition neural network that the client needs. Then, the cloud server sends the gesture recognition neural network to the client device. The client device may send the gesture recognition neural network to the terminal. Optionally, when the client device is a server, the terminal may alternatively download the gesture recognition neural network from the client device.

After receiving the gesture recognition neural network, the terminal may perform a gesture recognition method. The method may include the following steps: The terminal obtains a to-be-recognized image by using a camera, and inputs the to-be-recognized image to the gesture recognition neural network, to predict a gesture type corresponding to the to-be-recognized image. Further, the terminal may perform a corresponding operation based on the recognized gesture type, for example, perform an operation of opening the “Camera” application when recognizing a first gesture. The first gesture may be any one of a plurality of different gestures that the gesture recognition neural network can recognize.

It should be understood that, for specific implementation in which the cloud server automatically generates the object recognition neural network or the gesture recognition neural network based on the dataset in the scenario A or the scenario B, refer to related descriptions in the following method embodiments. Details are not described herein.

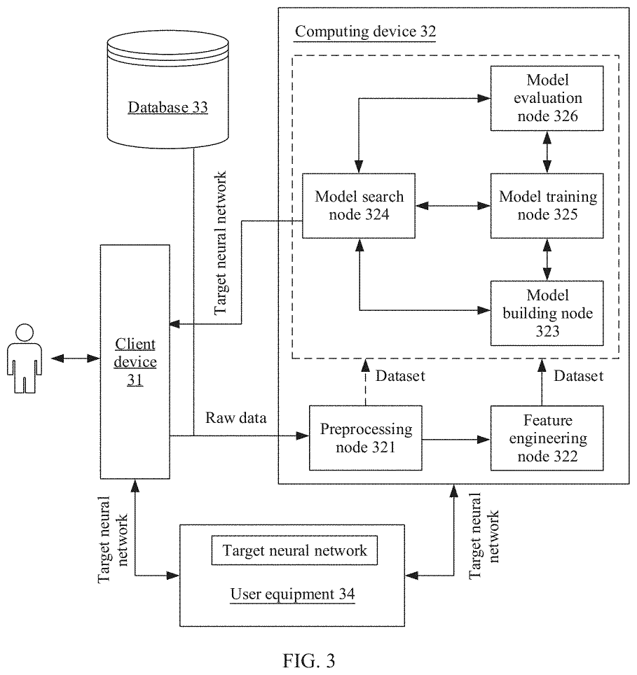

The following describes a system architecture in embodiments of this application, FIG. 3 is a schematic diagram of an architecture of a system according to an embodiment of this application.

A computing device 32 may include a part or an entirety of the AutoML architecture shown in FIG. 1. The computing device 32 may automatically generate, based on raw data or a dataset stored in a database 33 or raw data or a dataset sent by a client device 31, a machine learning model that can perform a specific function, for example, the object recognition neural network in the scenario A or the gesture recognition neural network in the scenario B.

The computing device 32 may include a plurality of nodes. The computing device 32 may be a distributed computing system, and the plurality of nodes included in the computing device 32 may be computer devices having a computing capability. Alternatively, the computing device 32 may be a device, and the plurality of nodes included in the computing device 32 may be function modules/components or the like in the computing device 32. A preprocessing node 321 is configured to perform preprocessing, for example, data cleaning, on received raw data. A feature engineering node 322 performs feature engineering on preprocessed raw data, to obtain a dataset. In some other embodiments, preprocessed raw data is a dataset. The dataset may be classified into a training dataset and a testing dataset.

A model building node 323 is configured to randomly generate a neural network architecture based on the training dataset and configure a hyperparameter for the architecture, to obtain an initialized neural network. A model search node 324 is configured to perform a neural network search method, to perform a plurality of evolutions on the initialized neural network, to obtain a final neural network obtained after evolution. The model building node 323 is configured to mutate a neural network in an evolution process, to obtain a candidate neural network. A model training node 325 may train the initialized neural network, the candidate neural network, and the like, to obtain a trained neural network. A model evaluation node 326 is configured to test the trained neural network based on the testing dataset, to obtain an evaluation parameter, for example, accuracy, a running time, or a parameter quantity, of the trained neural network. The model search node 324 is configured to select from the candidate neural network based on a partial order pruning algorithm before neural network training and testing, so that only a neural network whose network structure is superior to that before mutation is trained and tested. This reduces a neural network search space, improving neural network search efficiency. The model search node 324 is further configured to select, based on the evaluation parameter that is of the trained neural network and that is obtained by the model evaluation node 326, one or more optimal neural networks or a Pareto-optimal neural network as a neural network entering a next evolution. One or more neural networks are obtained after a plurality of evolutions, and a target neural network can be obtained by combining the obtained neural network or neural networks with modules such as feature engineering and preprocessing. The computing device 32 may send the target neural network to the client device 31.

The system may further include user equipment 34. After the client device 31 or the computing device 32 obtains the target neural network, the user equipment 34 may download the target neural network from the client device 31 or the computing device 32, so as to predict to-be-predicted data by using the target neural network, to obtain a prediction result. Alternatively, the user equipment 34 may send to-be-predicted data to the client device 31. After receiving the to-be-predicted data, the client data 31 inputs the to-be-predicted data to the target neural network, to obtain a prediction result, and then sends the prediction result to the user equipment 34. The target neural network may be the object recognition neural network in the scenario A or the gesture recognition neural network in the scenario B. The to-be-predicted data may be the to-be-recognized image in the scenario A or the scenario B.

The computing device 32 and the nodes in the computing device 32 each may be a cloud server, a server, a computer device, a terminal device, or the like. Details are not described herein.

The client device 31 or the user equipment 34 may be a mobile phone, a tablet computer, a personal computer, a vehicle, a vehicle-mounted unit, a point of sales (point of sales, POS), a personal digital assistant (personal digital assistant, PDA), an uncrewed aerial vehicle, a smart watch, smart glasses, a VR device, or the like. This is not limited herein. The client device 31 may alternatively be a server.

It should be noted that the preprocessing node 321, the feature engineering node 322, the model building node 323, the model training node 325, the model evaluation node 326, and the like are not necessary nodes of the computing device 32. Functions implemented by one or more of the preprocessing node 321, the feature engineering node 322, the model building node 323, the model training node 325, and the model evaluation node 326 may alternatively be integrated in the model search node 324.

The client device 31, the user equipment 34, and the database 33 in the system are not devices required by the system. The system does not include the foregoing devices, or may include other devices or functional units. This is not limited in this embodiment of this application.

As described in the foregoing basic concepts, the convolutional neural network is a deep neural network with a convolutional structure, and is a deep learning (deep learning) architecture. In the deep learning architecture, multi-layer learning is performed at different abstract levels according to a machine learning algorithm. As a deep learning architecture, the CNN is a feed-forward (feed-forward) artificial neural network, and each neuron in the feed-forward artificial neural network can respond to an image input into the feed-forward artificial neural network.

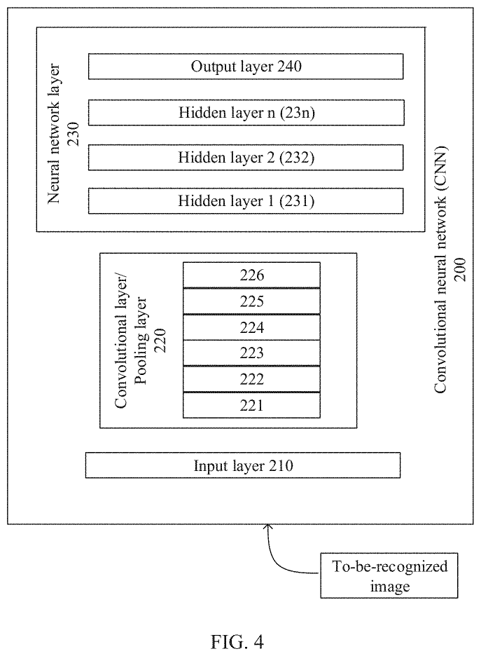

As shown in FIG. 4, a convolutional neural network (CNN) 200 may include an input layer 210, a convolutional layer/pooling layer 220 (the pooling layer is optional), and a neural network layer 230.

Convolutional Layer/Pooling Layer 220:

Convolutional Layer:

As shown in FIG. 4, the convolutional layer/pooling layer 220 may include, for example, layers 221 to 226. For example, in an implementation, the layer 221 is a convolutional layer, the layer 222 is a pooling layer, the layer 223 is a convolutional layer, the layer 224 is a pooling layer, the layer 225 is a convolutional layer, and the layer 226 is a pooling layer. In another implementation, 221 and 222 are convolutional layers, 223 is a pooling layer, 224 and 225 are convolutional layers, and 226 is a pooling layer. In other words, output of a convolutional layer may be used as input for a subsequent pooling layer, or may be used as input for another convolutional layer, to continue to perform a convolution operation.

The following describes internal working principles of the convolutional layer by using the convolutional layer 221 as an example.

The convolutional layer 221 may include a plurality of convolution operators. The convolution operator is also referred to as a kernel. In image processing, the convolution operator functions as a filter that extracts specific information from an input image matrix. The convolution operator may essentially be a weight matrix, and the weight matrix is usually predefined. In a process of performing a convolution operation on an image, the weight matrix usually processes pixels at a granularity level of one pixel (or two pixels, depending on a value of a stride (stride)) in a horizontal direction on an input image, to extract a specific feature from the image. A size of the weight matrix needs to be related to a size of the image. It should be noted that a depth dimension (depth dimension) of the weight matrix is the same as that of the input image. In a convolution operation process, the weight matrix extends to the entire depth of the input image. Therefore, a convolutional output of a single depth dimension is generated through convolution with a single weight matrix. However, in most cases, a single weight matrix is not used, but a plurality of weight matrices with a same size (rows×columns), namely, a plurality of same-type matrices, are applied. Outputs of the weight matrices are stacked to form a depth dimension of a convolutional image. The dimension herein may be understood as being determined based on the foregoing “a plurality of”. Different weight matrices may be used to extract different features from the image. For example, one weight matrix is used to extract edge information of the image, another weight matrix is used to extract a specific color of the image, and a further weight matrix is used to blur unneeded noise in the image. The plurality of weight matrices have the same size (rows×columns). Sizes of feature maps extracted by using the plurality of weight matrices with the same size are also the same, and then the plurality of extracted feature maps with the same size are combined to form an output of a convolution operation.

Weight values in these weight matrices need to be obtained through a lot of training in actual application. Each weight matrix constituted by the weight values obtained through training may be used to extract information from an input image, to enable the convolutional neural network 200 to perform correct prediction.

When the convolutional neural network 200 has a plurality of convolutional layers, an initial convolutional layer (for example, the layer 221) usually extracts more general features, where the general features may also be referred to as low-level features. As a depth of the convolutional neural network 200 increases, a deeper convolutional layer (for example, the layer 226) extracts more complex features, such as high-level semantic features. Higher-level semantic features are more applicable to a problem to be resolved.

Pooling Layer:

Because a quantity of training parameters usually needs to be reduced, a pooling layer usually needs to be periodically introduced behind a convolutional layer. For the layers 221 to 226 shown in 220 in FIG. 4, one convolutional layer may be followed by one pooling layer, or a plurality of convolutional layers may be followed by one or more pooling layers. During image processing, the pooling layer is only used to reduce a space size of an image. The pooling layer may include an average pooling operator and/or a maximum pooling operator, to sample an input image to obtain a smaller image. The average pooling operator may be used to calculate pixel values in an image in a specific range, to generate an average value. The average value is used as an average pooling result. The maximum pooling operator may be used to select a pixel with a maximum value in a specific range as a maximum pooling result. In addition, similar to that a size of a weight matrix at the convolutional layer needs to be related to a size of an image, an operator at the pooling layer also needs to be related to a size of the image. A size of a processed image output from the pooling layer may be less than the size of an image input into the pooling layer. Each sample in the image output from the pooling layer represents an average value or a maximum value of a corresponding sub-region of the image input into the pooling layer.

Neural Network Layer 230:

After processing is performed by the convolutional layer/pooling layer 220, the convolutional neural network 200 still cannot output required output information. As described above, at the convolutional layer/pooling layer 220, only a feature is extracted, and parameters resulting from an input image are reduced. However, to generate final output information (required class information or other related information), the convolutional neural network 200 needs to use the neural network layer 230 to generate output of one required category or output of a quantity of a group of required categories. Therefore, the neural network layer 230 may include a plurality of hidden layers (231, 232, . . . , and 23n shown in FIG. 4) and an output layer 240. Parameters included in the plurality of hidden layers may be obtained through pre-training based on related training data of a specific task type. For example, the task types may include image recognition, image categorization, and super-resolution image reconstruction.

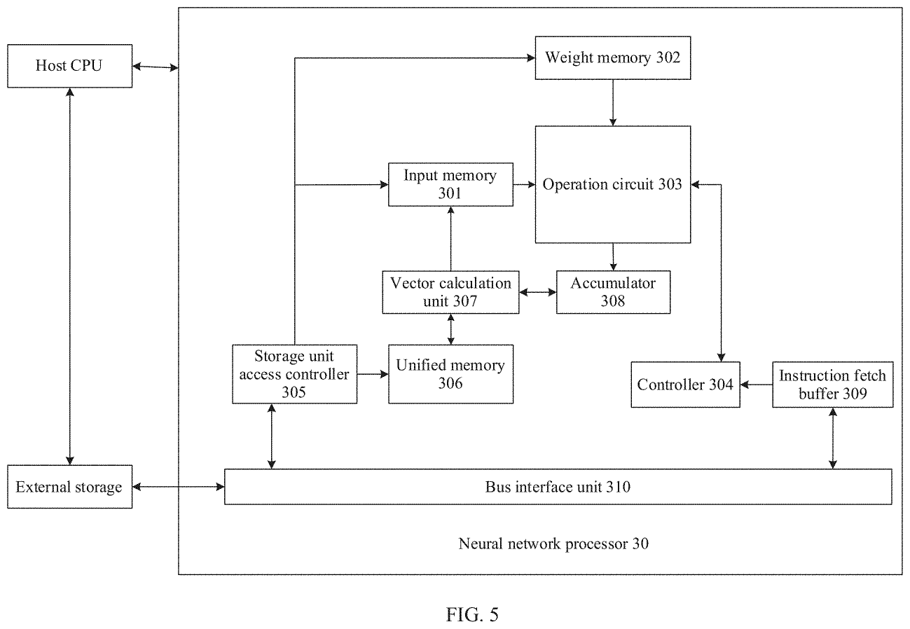

At the neural network layer 230, the plurality of hidden layers are followed by the output layer 240, namely, the last layer of the entire convolutional neural network 200. The output layer 240 has a loss function similar to a categorical cross entropy, and the loss function is specifically configured to calculate a prediction error. Once forward propagation of the entire convolutional neural network 200 (for example, propagation in a direction from 210 to 240 in FIG. 5 is forward propagation) is completed, back propagation (for example, propagation in a direction from 240 to 210 in FIG. 4 is back propagation) is started to update a weight value and a deviation of each layer mentioned above, to reduce a loss of the convolutional neural network 200 and an error between a result output by the convolutional neural network 200 by using the output layer and an ideal result.

It should be noted that the convolutional neural network 200 shown in FIG. 4 is merely used as an example of a convolutional neural network. In specific application, the convolutional neural network may alternatively exist in a form of another network model.

The following describes a hardware structure of a chip provided in embodiments of this application.

FIG. 5 shows a hardware structure of a chip according to an embodiment of the present invention. The chip includes a neural network processor 30. The chip may be disposed in the computing device 32 shown in FIG. 3, and is configured to complete calculation work for neural network training and testing. The chip may alternatively be disposed in the client device 31 or the user equipment 34 shown in FIG. 3, and is configured to complete prediction work for to-be-predicted data by using a target neural network. An algorithm of each layer of the convolutional neural network shown in FIG. 4 or a deep residual neural network may be implemented in the chip shown in FIG. 5.

The neural network processing unit 30 may be any processor, such as an NPU, a TPU, or a GPU, suitable for large-scale exclusive OR operation processing. The NPU is used as an example. The NPU may be disposed, as a coprocessor, on a host CPU (Host CPU), and the host CPU allocates a task to the NPU. A core part of the NPU is an operation circuit 303. The operation circuit 303 is controlled by a controller 304 to extract matrix data from memories (301 and 302) and perform multiplication and addition.

In some implementations, the operation circuit 303 internally includes a plurality of processing units (Process Engine, PE). In some implementations, the operation circuit 303 is a two-dimensional systolic array. The operation circuit 303 may alternatively be a one-dimensional systolic array or another electronic circuit that can perform mathematical operations such as multiplication and addition. In some implementations, the operation circuit 303 is a general-purpose matrix processor.

For example, it is assumed that there are an input matrix A, a weight matrix B, and an output matrix C. The operation circuit 303 obtains weight data of the matrix B from the weight memory 302, and buffers the weight data on each PE in the operation circuit 303. The operation circuit 303 obtains input data of the matrix A from the input memory 301, performs a matrix operation based on the input data of the matrix A and the weight data of the matrix B, to obtain a partial result or a final result of the matrix, and stores the partial result or the final result into an accumulator (accumulator) 308.

The unified memory 306 is configured to store input data and output data. The weight data is directly transferred to the weight memory 302 by using a storage unit access controller (DMAC, Direct Memory Access Controller) 305. The input data is also transferred to the unified memory 306 by using the DMAC.

A bus interface unit (BIU, Bus Interface Unit) 310 is used for interaction between the DMAC and an instruction fetch buffer (Instruction Fetch Buffer) 309. The bus interface unit 301 is further used by the instruction fetch buffer 309 to obtain an instruction from an external memory. The bus interface unit 301 is further used by the storage unit access controller 305 to obtain raw data of the input matrix A or the weight matrix B from the external memory.

The DMAC is mainly configured to transfer input data in an external memory DDR to the unified memory 306, or transfer the weight data to the weight memory 302, or transfer the input data to the input memory 301.

A vector calculation unit 307 includes a plurality of operation processing units, and if required, performs further processing such as vector multiplication, vector addition, an exponential operation, a logarithmic operation, or value comparison on an output of the operation circuit 303. The vector calculation unit 307 is mainly configured for calculation at a non-convolutional layer or a fully connected layer (FC, fully connected layers) of the neural network, and may specifically perform calculation in pooling (pooling), normalization (normalization), and the like. For example, the vector calculation unit 307 may apply a non-linear function to the output of the operation circuit 303, for example, to a vector of an accumulated value, to generate an activation value. In some implementations, the vector calculation unit 307 generates a normalized value, a combined value, or both.

In some implementations, the vector calculation unit 307 stores a processed vector into the unified memory 306. In some implementations, a vector processed by the vector calculation unit 307 can be used as an active input for the operation circuit 303, for example, for use at a subsequent layer in the neural network. As shown in FIG. 4, if a current processing layer is a hidden layer 1 (231), the vector processed by the vector calculation unit 307 can also be used for calculation at a hidden layer 2 (232).

The instruction fetch buffer (instruction fetch buffer) 309 connected to the controller 304 is configured to store an instruction used by the controller 304.

The unified memory 306, the input memory 301, the weight memory 302, and the instruction fetch buffer 309 are all on-chip memories. The external memory is independent of a hardware architecture of the NPU.

Operation at each layer of the convolutional neural network shown in FIG. 4 or calculation by each residual unit in the deep residual network may be performed by the operation circuit 303 or the vector calculation unit 142.

### Embodiment 1

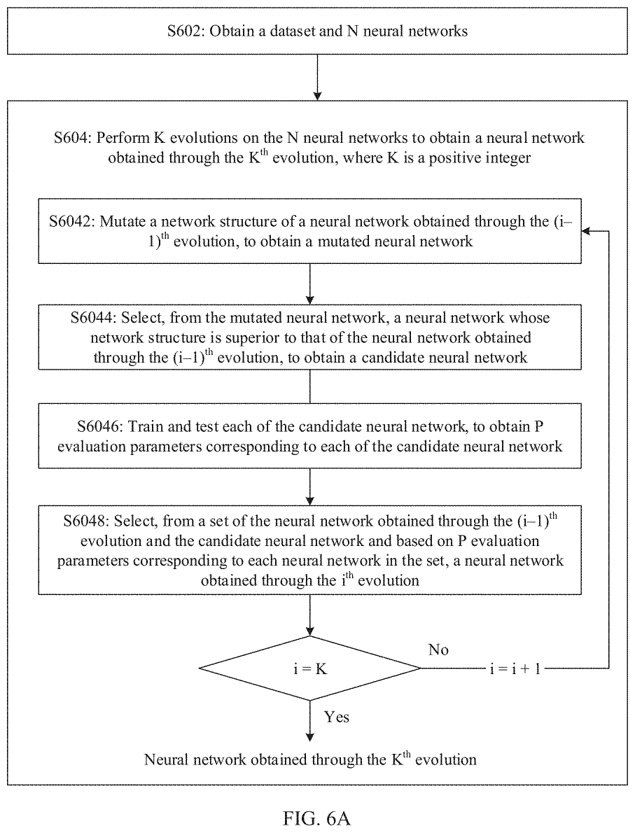

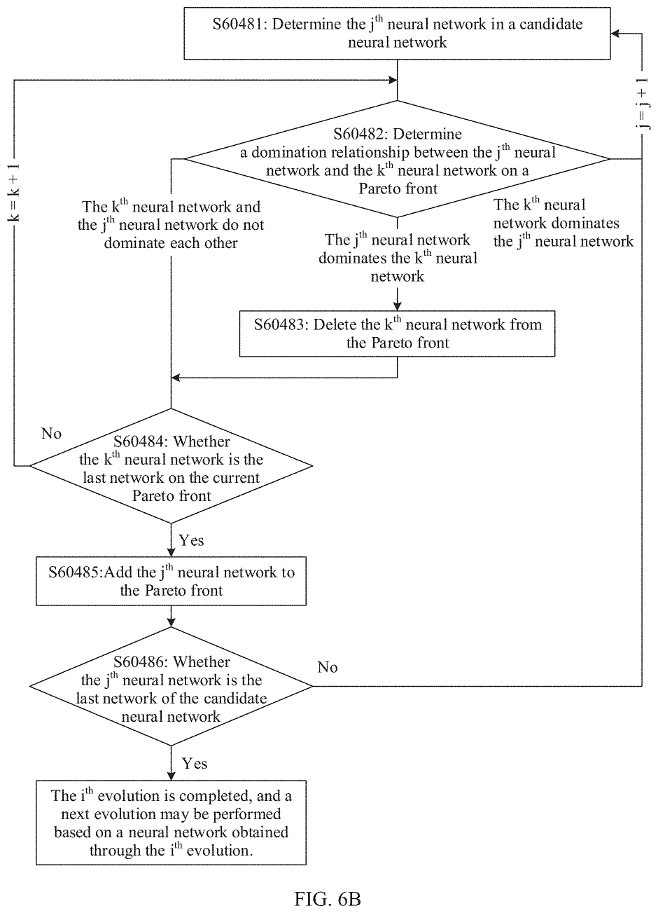

FIG. 6A shows a neural network search method according to an embodiment of this application. The method may be used to search for the object recognition neural network in the scenario A or the gesture recognition neural network in the scenario B. The neural network search method provided in this embodiment of this application may be applied to an AutoML architecture, to implement automatic generation of a machine learning model. The method 60 may be performed by the computing device 320 shown in FIG. 3. In another implementation, a computing device may be a distributed computing device, including a preprocessing node 321, a feature engineering node 322, a model building node 323, a model search node 324, a model training node 325, a model evaluation node 326, and the like. In the method 60, step S6021 for obtaining a dataset and the like in step S602 may be performed by the preprocessing node 321 or the feature engineering node 322, obtaining N neural networks in step S602 and step S6042 may be performed by the model building node 323; training processes in steps S6022 and S6046 may be performed by the model training node 325; testing processes in steps S6022 and S6046 may be performed by the model evaluation node 326; and steps S6023, S604, S6044, and S6048 may be performed by the model search node 324. Optionally, step S602 and step S6042 may alternatively be performed by the model evaluation node 326. Optionally, the method 60 or the steps in the method may be separately processed by a CPU, may be jointly processed by a CPU and a GPU, or may be processed by another processor suitable for neural network computation, such as the neural network processor 40 shown in FIG. 4, instead of a GPU. This is not limited herein. In this embodiment of this application, as an example for description, an execution body is the computing device. The method 60 may include some or all of the following steps.

S602: The computing device obtains a dataset and N neural networks, where N is a positive integer.

The dataset in the method 60 may be raw data that has undergone data cleaning or may be a dataset obtained after raw data undergoes feature engineering. The raw data or the dataset may come from the database 330 shown in FIG. 3, or may be collected or obtained by the client device 310.

The dataset may include a training dataset and a testing dataset. The training dataset is for training an initialized neural network. The testing dataset is for testing performance, for example, accuracy and a running time, of a trained neural network. The training dataset includes a plurality of training samples, the testing dataset may include a plurality of testing samples, and a training sample or a testing sample may include input data and a tag. Input data of a training sample is used to be input to an initialized neural network, to obtain a prediction result corresponding to the input data. A tag is an actual result corresponding to the input data. A deviation of the actual result from a prediction result is for reflecting and adjusting a model parameter of the initialized neural network, to obtain a trained neural network. However, input data of a testing sample is used to be input to the trained neural network, to obtain a prediction result corresponding to the input data. Accuracy of the trained neural network is evaluated based on a deviation between the prediction result and an actual result. Alternatively, the input data is input to the trained neural network, to test a running time or the like of the trained neural network.

In some embodiments, the N neural networks may be one or more manually built neural networks, or may be one or more neural network randomly generated by the computing device.

In some other embodiments, the N neural networks may alternatively be N neural networks selected from M randomly generated neural networks, where M is a positive integer not less than N. An implementation in which the computing device obtains the N neural networks may include but is not limited to the following steps:

S6021: The computing device randomly generates M neural networks, where M is a positive integer.

For specific implementation of randomly generating M neural networks, refer to related descriptions in the following embodiment of a method of randomly generating a neural network. Details are not described herein.

S6022: The computing device trains and tests each of the M neural networks by using the dataset, to obtain P evaluation parameters corresponding to each of the M neural networks.

S6023: The computing device selects N neural networks from the M neural networks based on the P evaluation parameters corresponding to each of the M neural networks, where N is not greater than M.

In a specific implementation, the computing device selects, from the M neural networks, a neural network whose P evaluation parameters meet a preset condition. For example, a neural network whose accuracy is greater than a preset threshold (for example, 90%) and whose running time is less than first duration (for example, 2s) is selected from the M neural networks, to obtain the N neural networks.

S604: The computing device performs K evolutions on the N neural networks to obtain a neural network obtained through the K^{th} evolution, where K is a positive integer, the evolution is used as an example to describe a process of the K evolutions, i is a positive integer not greater than K, and the evolution includes but is not limited to the following steps.

S6042: The computing device mutates a network structure of a neural network obtained through the (i−1)^{th} evolution, to obtain a mutated neural network, where a neural network obtained through the 0^{th} evolution is the N neural networks.

The computing device may mutate one or more neural networks of the neural network obtained through the (i−1)^{th} evolution, or may mutate each of the neural network obtained through the (i−1)^{th} evolution. For specific implementation of mutating a neural network, refer to related descriptions in the following embodiment of a method of mutating a neural network. Details are not described herein.

S6044: The computing device selects, from the mutated neural network, a neural network whose network structure is superior to that of the neural network obtained through the (i−1)^{th} evolution, to obtain a candidate neural network.

It should be understood that a neural network and a neural network obtained by mutating the neural network are networks with similar topology structures. In networks with similar topology structures, a wider and deeper network is superior to a narrower and shallower network. Therefore, preliminary network selection may be performed based on depths and widths of networks, to filter out poor networks. Herein, “wide” and “narrow” both describe a channel quantity of a network, and “deep” and “shallow” both describe a layer quantity of a network. In other words, in networks with similar topology structures, a network is better as a layer quantity and a channel quantity are larger. For example, for CNNs with similar topology structures, a network is better as a layer quantity and a channel quantity are larger; and for ResNets with similar topology structures, a network is better as a residual unit quantity and a channel quantity are larger.

In this embodiment of this application, each of the neural network obtained through the (i−1)^{th} evolution may be mutated. During selection from a neural network obtained by mutating a neural network, only a network whose network structure is superior to that of the neural network before the mutation is selected and used as a candidate neural network. It should be understood that the candidate neural network is the selected neural network and includes at least one neural network.

It can be learned that in this embodiment of this application, a neural network is mutated, to generate a neural network with a similar topology structure as the neural network. A neural network search space is pruned by using features of the neural networks that have similar topology structures. This reduces a quantity of neural networks that need to be trained and tested, improving efficiency in automatic machine learning.

S6046: The computing device trains and tests each of the candidate neural network, to obtain P evaluation parameters corresponding to each of the candidate neural network, where P is a positive integer.

The dataset may be classified into a training dataset and a testing dataset. The computing device trains each of the candidate neural network by using the training dataset, and then evaluates a trained neural network by using the testing dataset, to obtain P evaluation parameters corresponding to each neural network. An evaluation parameter is for evaluating performance of the neural network obtained after training by using the training dataset, such as at least one of accuracy, a running time, or a parameter quantity.

S6048: The computing device selects, from a set of the neural network obtained through the (i−1)^{th} evolution and the candidate neural network and based on P evaluation parameters corresponding to each neural network in the set, a neural network obtained through the evolution.

After S6048, the computing device may determine whether i is equal to K, that is, determines whether the i^{th} evolution is the last evolution; and if yes, outputs a neural network obtained through the K^{th} evolution. Otherwise, let i=i+1, and repeat S6042 to perform a next evolution based on the neural network obtained through the i^{th} evolution. In another embodiment of this application, alternatively, whether an evaluation parameter of the neural network obtained through the (i−1)^{th} evolution meets a condition may be determined. For example, whether accuracy of each of the neural network obtained through the i^{th} evolution is greater than preset accuracy and whether a running time of each of the neural network obtained through the i^{th} evolution is less than preset duration are determined. If yes, a neural network obtained through the K^{th} evolution is output. Otherwise, let i=i+1, and repeat S6042. The preset accuracy and the preset duration may be set by a client and sent to the computing device by using a client device, and indicate accuracy, a running time, and the like of a target neural network that the client needs.

It should be understood that the neural network obtained through the K^{th} evolution may be a trained neural network. The computing device may select, based on a requirement of the client on P evaluation parameters of a neural network and from the neural network obtained through the K^{th} evolution or a neural network obtained by combining the neural network obtained through the K^{th} evolution with a feature engineering module and a data preprocessing module, a target neural network that meets the requirement of the client; and then send the neural network to the client device. The computing device may alternatively send, as a target neural network to the client device, the neural network obtained through the K^{th} evolution or a neural network obtained by combining the neural network obtained through the K^{th} evolution separately with a feature engineering module and a data preprocessing module. This is not limited herein. The target neural network may be the object recognition neural network in the scenario A. In this case, the dataset includes a plurality of samples, and each sample includes a sample image and an object type corresponding to the sample image. The target neural network may alternatively be the gesture recognition neural network in the scenario B. In this case, the dataset includes a plurality of samples, and each sample includes a sample image and a gesture type corresponding to the sample image.

The following specially describes a specific implementation of S6048.

It should be understood that the neural network obtained through the (i−1)^{th} evolution has been trained and tested in a process of the (i−1)^{th} evolution, and P evaluation parameters corresponding to each of the neural network obtained through the (i−1)^{th} evolution are obtained. It should be understood that the neural network obtained through the 0^{th} evolution is the N neural networks. In a process of the first evolution or before the first evolution, the computing device may train each of the N neural networks by using the training dataset, and then evaluates a trained neural network by using the testing dataset, to obtain P evaluation parameters corresponding to each of the N neural networks.

In an implementation, P=1. For example, the P evaluation parameter is accuracy. In this case, the neural network obtained through the i^{th} evolution may be selected from a set based on accuracy. For example, Q neural networks with highest accuracy are selected from the set as neural networks obtained after the i^{th} evolution. For another example, a neural network whose accuracy is greater than a preset value, for example, 90%, is selected from the set as the neural network obtained through the i^{th} evolution.

In another implementation, P>1. The computing device performs non-dominated sorting on neural networks in a set based on P evaluation parameters corresponding to each neural network in the set, and then determines that the neural network obtained through the (i−1)^{th} evolution is a neural network that is not dominated in the set. Each of P evaluation parameters corresponding to a dominating neural network is not inferior to that of a dominated neural network, and at least one of the P evaluation parameters corresponding to the dominating neural network is superior to that of the dominated neural network. For example, the P evaluation parameters are accuracy and a running time. A neural network A and a neural network B are two neural networks in the set. When the neural network A and the neural network B meet at least one of the following two conditions, the neural network A dominates the neural network B:

(1) Accuracy of the neural network A is higher than accuracy of the neural network B, and a running time of the neural network A is not greater than a running time of the neural network B.

(2) A running time of the neural network A is less than a running time of the neural network B, and accuracy of the neural network A is not lower than that of the neural network B.

In a specific implementation, each of the neural network obtained through the (i−1)^{th} evolution is not dominated by another neural network of the neural network obtained through the (i−1)^{th} evolution. In this case, the neural network obtained through the (i−1)^{th} evolution is also referred to as a neural network located on a Pareto front. FIG. 6B is a schematic flowchart of an implementation in which the computing device selects, from the set, the neural network obtained through the i^{th} evolution. The implementation may include but is not limited to the following steps:

S60481: Determine the j^{th} neural network in the candidate neural network, where j is a positive integer, and j is not greater than a total quantity of neural networks in the candidate neural network.

S60482: Determine a domination relationship between the j^{th} neural network and the k^{th} neural network on the Pareto front, where k is a positive integer, and k is not greater than a total quantity of neural networks in the neural network obtained through the (i−1)^{th} evolution. If the k^{th} neural network dominates the j^{th} neural network, it is impossible for the j^{th} neural network to locate on the Pareto front. In this case, it is unnecessary to compare the j^{th} neural network with each neural network on the Pareto front. Let j=j+1, and repeat S60482. If the j^{th} neural network dominates the k^{th} neural network, perform S60483. If the j^{th} neural network does not dominate the k^{th} neural network, and the k^{th} neural network does not dominate the j^{th} neural network either, perform S60484.

When j=1 and k=1, a neural network on the Pareto front is the neural network obtained through the (i−1)^{th} evolution.

When the domination relationship between the j^{th} neural network and the k^{th} neural network is determined, if each of P evaluation parameters corresponding to the j^{th} neural network is not inferior to that of the k^{th} neural network, and at least one of the P evaluation parameters corresponding to the j^{th} neural network is superior to that of the k^{th} neural network, the j^{th} neural network dominates the k^{th} neural network. On the contrary, when the domination relationship between the k^{th} neural network and the j^{th} neural network is determined, if each of P evaluation parameters corresponding to the k^{th} neural network is not inferior to that of the j^{th} neural network, and at least one of the P evaluation parameters corresponding to the k^{th} neural network is superior to that of the j^{th} neural network, the k^{th} neural network dominates the j^{th} neural network. If at least one of the P evaluation parameters corresponding to the j^{th} neural network is not inferior to that of the k^{th} neural network, and at least one of the P evaluation parameters corresponding to the k^{th} neural network is not inferior to that of the j^{th} neural network, the j^{th} neural network and the k^{th} neural network do not dominate each other.

S60483: Delete the k^{th} neural network from the current Pareto front.

S60484: Determine whether the k^{th} neural network is the last network on the Pareto front. If no, the j^{th} neural network needs to continue to be compared with a next network on the Pareto front. In this case, let k=k+1, and repeat S60482. Otherwise, the k^{th} neural network is the last network on the Pareto front. In this case, perform S60485.

S60485: Add the j^{th} neural network to the Pareto front.

After step S60485, further perform S60486.

S60486: Determine whether the j^{th} neural network is the last network of the candidate neural network. If yes, the evolution is completed, and a next evolution may be performed based on a neural network obtained through the i^{th} evolution. Otherwise, let j=j+1, and repeat S60482.

For example, as an example for description, the P evaluation parameters are accuracy and a running time. If a running time of a neural network NN 1 of the candidate neural network is shorter than a running time of a neural network NN 2 on the Pareto front, and accuracy of the neural network NN 1 is higher than that of the neural network NN 2, the neural network NN 1 dominates the neural network NN 2 on the Pareto front. Then, the dominated neural network NN 2 is removed from the Pareto front, and the dominating neural network NN 1 is added to the Pareto front. If the neural network NN 1 does not dominate a neural network on the Pareto front and is not dominated by a neural network on the Pareto front either, the neural network NN 1 is a new Pareto-optimal network, and the neural network NN 1 is directly added to the Pareto front. If the neural network NN 1 is dominated by a neural network on the Pareto front, the Pareto front is not updated.

It should be noted that after a plurality of evolutions, an obtained neural network is increasingly better. After a fixed quantity of evolutions (for example, K=10), or when P evaluation parameters of a neural network obtained through the K^{th} evolution meet the requirement of the client, evolution may be stopped, and the neural network obtained through the K^{th} evolution is output.

In addition, in this embodiment of this application, a multi-objective optimization solution is used. In this way, a balance can be achieved for the P evaluation parameters of the neural network obtained through the K^{th} evolution, avoiding a case in which one evaluation parameter is good but other evaluation parameters are poor in the neural network obtained through the K^{th} evolution.

The following uses a ResNet and a CNN as examples to describe the method of randomly generating a neural network and the method of mutating a neural network in embodiments of this application.

The neural network obtained through the K^{th} evolution is a network determined from a search space by using the neural network search method according to Embodiment 1. The search space is built by using a basic unit and a parameter of the basic unit. The search space is for searching for the neural network obtained through the K^{th} evolution. The parameter of the basic unit includes at least one of a type, a channel quantity parameter, and a size parameter of the basic unit. The basic unit is configured to perform a first operation and a second operation on a feature map input to the basic unit, the first operation is for doubling or maintaining a quantity of feature maps input to the basic unit, the second operation is for changing a size of the feature map input to the basic unit from an original first size to a second size or maintain the first size, and the first size is greater than the second size. A size herein may be a side length or an area of the feature map. The channel quantity parameter is used to indicate a change, for example, doubling or maintaining, of a quantity of feature maps obtained through processing by the basic unit. The size parameter is used to indicate a change, for example, reducing by half or maintaining, of a size of the feature map obtained through processing by the basic unit.

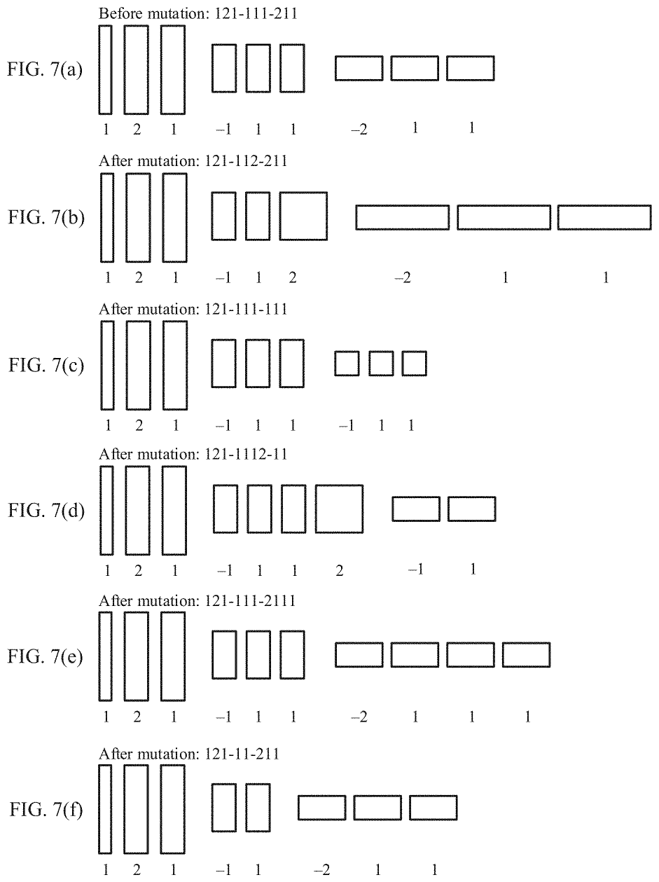

In some embodiments, a neural network may be a ResNet, and a basic unit is also referred to as a residual unit. The ResNet may include a plurality of residual units and at least one fully connected layer. Each residual unit may include at least two (for example, three) convolutional layers. A quantity of fully connected layers may be preset or varying. This is not limited herein. A network structure of the ResNet is coded by using a parameter of a residual unit. For example, residual units in the ResNet are represented by using ordered symbols. For example, a residual unit whose code is “1” represents that a channel quantity of the residual unit remains unchanged, a residual unit whose code is “2” represents that a channel quantity of the residual unit is doubled, and a residual unit whose code is prefixed by “-” represents that a feature map size of the residual unit is reduced by half. For example, a network structure of a ResNet whose code is “121-21.1-121” is shown in FIG. 7. In FIG. 7(a) to FIG. 7(f), a width of a residual unit is for reflecting a channel quantity of the residual unit, and a length of the residual unit reflects a size of a feature map of the residual unit.

A ResNet is obtained by combining several characters such as “1”, “2”, and “-”. A process in which a computing device randomly generates a ResNet may be converted into a process of randomly generating a character string. It should be understood that when the computing device randomly generates a character string, a constraint condition needs to be added, or a randomly generated character string needs to be filtered, to remove a ResNet that does not meet a requirement. For example, two “-” characters cannot be arranged consecutively.

The computing device may mutate one ResNet to generate a plurality of imitated ResNets. Each mutated neural network is generated by mutating a ResNet for once. In this embodiment of this application, the computing device may specifically mutate a ResNet for once in one of the following implementations:

(1) Randomly change a channel quantity (that is, a channel quantity parameter) of a residual unit from maintaining a channel quantity to doubling the channel quantity, in a specific implementation, a random “1” in a code of the ResNet may be changed to “2”. For example, when a channel quantity of the sixth residual unit in a ResNet shown in FIG. 7(a) is changed from maintaining an original channel quantity to doubling the channel quantity, the ResNet whose code is “121-111-211” is mutated to a ResNet whose code is “121-112-211”, as shown in FIG. 7(h). It should be understood that original channel quantities of all residual units after the sixth residual unit are doubled.

(2) Randomly change a channel quantity of a residual unit from doubling a channel quantity to maintaining the channel quantity. In a specific implementation, a random “2” in a code of the ResNet may be changed to “1”. For example, when a channel quantity of the seventh residual unit in a ResNet shown in FIG. 7(a) is changed from doubling an original channel quantity to maintaining the channel quantity, the ResNet whose code is “121-111-211” is mutated to a ResNet whose code is “121-111-111”, as shown in FIG. 7(c). It should be understood that original channel quantities of all residual units after the seventh residual unit are reduced by 50%.

(3) Change a step size of a residual unit from an original value 2 to 1, and change a step size of another residual unit from an original value 1 to 2. In a specific implementation, a location of a character “-” in a code of the ResNet may be randomly changed. A step size of the seventh residual unit in a ResNet whose code is “121-211-111” in FIG. 7(a) is changed from 2 to 1, and a step size of the eighth residual unit is changed from 1 to 2, to obtain a mutated ResNet, that is, a ResNet whose code is “121-1112-11”, as shown in FIG. 7(d). A step size of a residual unit is determined by a step size of a convolution kernel corresponding to each of at least two convolutional layers included in the residual unit. For example, it is assumed that the residual unit includes two convolutional layers and that a step size of a convolution kernel corresponding to each convolutional layer is 1. Then, the step size of the residual unit is 1. If the step size of the residual unit is to be changed to 2, a step size of one of the two convolutional layers needs to be changed to 2. For example, a step size of the first convolutional layer is changed to 2.

(4) Randomly insert, into the ResNet, a residual unit whose channel quantity does not change. In a specific implementation, a “1” may be randomly inserted into a code of the ResNet. For example, a residual unit whose channel quantity does not change is added after the ninth residual unit in a ResNet shown in FIG. 7(a). To be specific, the ResNet whose code is “121-111-211” is mutated to a ResNet whose code is “121-111-2111”, as shown in FIG. 7(e).

(5) Randomly delete, from the ResNet, a residual unit whose channel quantity does not change. In a specific implementation, a random “1” may be deleted from a code of the ResNet. For example, the fifth residual unit is deleted from a ResNet shown in FIG. 7(a). In other words, the ResNet whose code is “121-111-211” is mutated to a ResNet whose code is “121-11-211”, as shown in FIG. 7(f).

This embodiment of this application may further include other mutation manners, without being limited to the foregoing five mutation manners. For example, a character “-” may be randomly added to the code of the ResNet or a character “-” may be randomly deleted from the code of the ResNet. For another example, a “2” may be randomly deleted from the code of the ResNet or a “2” may be randomly added to the code of the ResNet. A specific structure of a mutated ResNet of the ResNet may be deduced with reference to a meaning of a code of each residual unit. Details are not described herein.

In some embodiments, a neural network may be a convolutional neural network, and a basic unit may be referred to as a layer structure. The convolutional neural network may include a convolutional layer, a pooling layer, and a fully connected layer. A quantity of fully connected layers may be preset or varying. This is not limited herein. A network structure of the CNN is coded by using a parameter of a layer structure. The layer structure may be the convolutional layer or the pooling layer. For example, a sequence of layer structures in the CNN is represented by using ordered symbols. A layer structure whose code is “1” represents that the layer structure is a convolutional layer and a channel quantity of the layer structure remains unchanged. A layer structure whose code is “2” represents that the layer structure is a convolutional layer and a channel quantity of the layer structure is doubled. A layer structure whose code is prefixed by “-” represents that a step size of a convolution kernel in the layer structure changes from 1 to 2. A lay structure whose code is “3” represents that the layer structure is a pooling layer, and a size of a feature map is reduced by half. A layer structure whose code is “3”, “4”, or “5” represents that the layer structure is a pooling layer. A pooling layer whose code is “3” uses average pooling, a pooling layer whose code is “4” uses average pooling, and a pooling layer whose code is “5” uses LP pooling. In this embodiment of this application, as an example for description, a pooling layer chooses to perform a pooling operation on an area of 2×2 in an input image, to reduce a size of a feature map generated through convolution to ¼ an original size. In another implementation of this application, alternatively, a pooling layer of another type may be coded, or areas selected by pooling operations may be distinguished through coding. This is not limited herein.

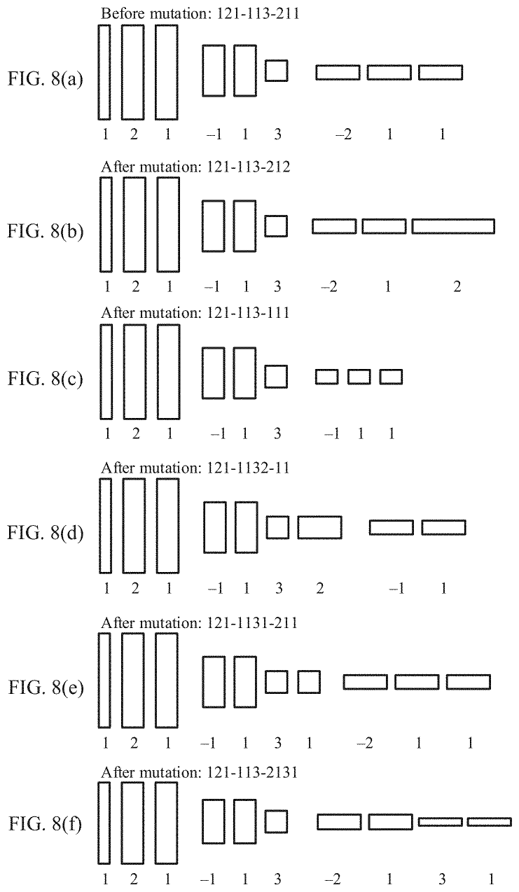

For example, a network structure of a CNN whose code is “121-113-211” is shown in FIG. 8(a). In FIG. 8(a) to FIG. 8(f), a width of a layer structure is for reflecting a channel quantity of the layer structure, and a length of the layer structure reflects a size of a feature map of the layer structure.

A CNN is obtained by combining several characters such as “I”, “2”, “-”, “3”, “4”, or “5”. A process in which a computing device randomly generates a CNN may be converted into a process of randomly generating a character string. It should be understood that when the computing device randomly generates a character string, a constraint condition needs to be added, or a randomly generated character string needs to be filtered, to remove a CNN that does not meet a requirement. For example, two characters “-” cannot be arranged consecutively, “-” is not followed by “3”, and pooling layers do not appear consecutively, that is, “3”, “4”, and “5” are not adjacent to each other.

The computing device may mutate one CNN to generate a plurality of mutated. CNNs. Each mutated neural network is generated by mutating a CNN for once. In this embodiment of this application, the computing device may specifically mutate a CNN for once in one of the following implementations:

(1) Randomly change a channel quantity of a convolutional layer in the CNN from maintaining a channel quantity to doubling the channel quantity. In a specific implementation, a random “1” in a code of the CNN may be changed to “2”. For example, when a channel quantity of the eighth layer structure in a CNN shown in FIG. 8(a) is changed from maintaining an original channel quantity to doubling the channel quantity, the CNN whose code is “121-113-211” is mutated to a CNN whose code is “121-113-212”, as shown in FIG. 8(b). It should be understood that original channel quantities of all layer structures after the eighth layer structure are doubled. It should be understood that, alternatively, channel quantities of a plurality of convolutional layers in the CNN may be doubled. This is not limited in this embodiment of this application.

(2) Randomly change a channel quantity of a convolutional layer in the CNN from doubling a channel quantity to maintaining the channel quantity. In a specific implementation, a random “2” in a code of the CNN may be changed to “1”. For example, when a channel quantity of the seventh layer structure in a CNN shown in FIG. 8(a) is changed from doubling an original channel quantity to maintaining the channel quantity, the CNN whose code is “121-113-211” is mutated to a CNN whose code is “121-113-111”, as shown in FIG. 8(c). It should be understood that original channel quantities of all layer structures after the seventh layer structure are reduced by 50%.

(3) Randomly swap locations of two convolutional layers in the CNN. In a specific implementation, locations of a symbol “1” and a symbol “2” in a code of the CNN may be randomly swapped, to obtain a code of a mutated CNN. For example, after a CNN whose code is “121-113-211” undergoes this mutation process, a code of a mutated CNN obtained is “112-113-211”.

(4) Randomly change a step size of a convolutional layer in the CNN from an original value 2 to 1, and change a step size of another convolutional layer from an original value 1 to 2. In a specific implementation, a location of a symbol “-” in a code of the CNN may be randomly moved from a location before a convolutional layer to a location before another convolutional layer. A step size of the third layer structure in a CNN whose code is “121-113-211” in FIG. 8(a) is changed from 2 to 1, and a step size of the fourth layer structure is changed from 1 to 2, to obtain a mutated CNN, that is, a CNN whose code is “121-1132-11”, as shown in FIG. 8(d).

(5) Randomly double a step size or step sizes of more or more convolutional layers in the CNN. In a specific implementation, one or more symbols “-” may be randomly inserted into a code of the CNN. After the symbol “-” is inserted, a code of the CNN does not include two adjacent symbols “-”, and the symbol “-” is not followed by “3”.

(6) Randomly swap locations of a convolutional layer and a pooling layer in the CNN. It should be understood that a pooling layer is not located at an initial location of the CNN. Locations of the fifth convolutional layer and the first pooling layer in a CNN whose code is “121-113-211” are swapped, to obtain a mutated CNN whose code is “121-131-211”.

(7) Randomly insert a convolutional layer into the CNN. The inserted convolutional layer may be a convolutional layer whose channel quantity does not change or may be a convolutional layer whose channel quantity is doubled. In a specific implementation, a “1” or a “2” may be randomly inserted into the code of the CNN. For example, a “1” is added after the fifth convolutional layer in a code of a CNN shown in FIG. 8(a). To be specific, the CNN whose code is “121-113-211” is mutated to a CNN whose code is “121-1131-211”, as shown in FIG. 8(e).

(8) Randomly delete a convolutional layer from the CNN. The convolutional layer may be a convolutional layer whose channel quantity does not change or may be a convolutional layer whose channel quantity is doubled. In a specific implementation, a “1” or a “2” may be randomly, deleted from a code of the CNN. For example, the eighth layer structure of the CNN is deleted. Then, a CNN whose code is “121-113-211” is mutated to a CNN whose code is “121-113-21”, as shown in FIG. 8(f). One or more symbols “1” are randomly deleted or one or more symbols “2” are randomly deleted from the code of the CNN.

(9) Randomly add one or more pooling layers to the CNN or randomly delete one or more pooling layers from the CNN. It should be noted that a pooling layer is not added before or after a pooling layer. In other words, a mutated CNN does not include two adjacent pooling layers. In a specific implementation, a “3” may be randomly deleted from a code of the CNN or a “3” may be randomly added to a code of the CNN, to obtain a mutated CNN. It should be understood that a CNN obtained by adding a “3” before or after a “3” needs to be filtered out. A pooling layer is added after the eighth layer structure of a CNN shown in FIG. 8(a). In other words, the CNN whose code is “121-113-211” is mutated to a CNN whose code “121-113-2131”, as shown in FIG. 8(f).

The CNN may further include other mutation operations, without being limited to the foregoing mutation operations. Details are not described herein.

It should be noted that a residual unit in the ResNet may include one or more of a common convolutional layer, a dilated convolutional layer, a depthwise separable convolutional layer, a fully connected layer, or the like. A convolutional layer in the CNN may be a common convolutional layer, a dilated convolutional layer, a depthwise separable convolutional layer, or the like. Internal network structures of residual units in the ResNet may be the same or different. Types of convolutional layers in the CNN may be the same or different. This is not limited in this embodiment of this application.

In an implementation, a residual unit in the ResNet may include only a common convolutional layer or include a combination of a common convolutional layer and a fully connected layer. A convolutional layer in the CNN may be a common convolutional layer and does not include a dilated convolutional layer or a depthwise separable convolutional layer. This avoids a problem that a neural network search method cannot be applied to a hardware platform because an NPU chip does not support a dilated convolutional layer or a depthwise separable convolutional layer, so that the neural network search method provided in this application can be widely applied to various devices or platforms.

### Embodiment 2

After obtaining a target neural network model, a computing device may send the target neural network model to a client device or user equipment. Then, the client device or the user equipment may implement a corresponding function based on the target neural network model.

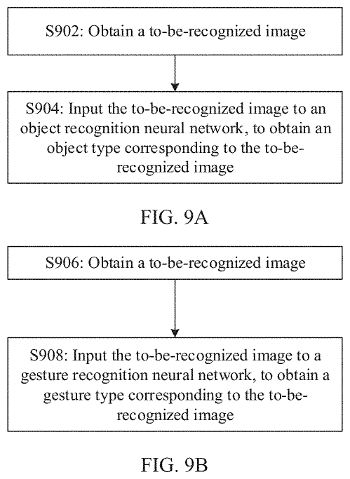

In an embodiment, for example, in the scenario A shown in FIG. 2A, the neural network search method in embodiments of this application may be applied to the autonomous driving field. For example, a vehicle obtains an image by using a camera, to observe an obstacle in an ambient environment of the vehicle in real time. In this way, the vehicle or a device communicatively connected to the vehicle may make a decision based on a recognized object in the ambient environment, to implement safe driving. FIG. 9A shows an object recognition method according to this embodiment of this application. The object recognition method may be performed by the vehicle in FIG. 2A or the client device 31 or the user equipment 34 in FIG. 3. The method includes but is not limited to the following steps:

S902: Obtain a to-be-recognized image.

S904: Input the to-be-recognized image to an object recognition neural network, to obtain an object type corresponding to the to-be-recognized image.

In some embodiments, the to-be-recognized image may be an image of an ambient environment obtained by the vehicle by using the camera. The to-be-recognized image is processed by using the object recognition neural network, to recognize an object in the ambient environment of the vehicle.

The object recognition neural network may be a network determined from a search space by using the neural network search method according to Embodiment 1. In this case, each sample in the dataset in Embodiment 1 includes a sample image and an object type corresponding to the sample image.

The search space is built by using a basic unit and a parameter of the basic unit. The search space is for searching for the object recognition neural network. The parameter of the basic unit includes at least one of a type, a channel quantity parameter, a size parameter, and the like of the basic unit. The basic unit is configured to perform a first operation and a second operation on a feature map input to the basic unit. Herein, the feature map is a feature map of the to-be-recognized image. The first operation is for doubling or maintaining a quantity of feature maps input to the basic unit, the second operation is for changing a size of the feature map input to the basic unit from an original first size to a second size or maintain the first size, and the first size is greater than the second size. For example, the first size is twice the second size. Herein, a size is a side length of the feature map. The channel quantity parameter is used to indicate a change, for example, doubling or maintaining, of a quantity of feature maps obtained through processing by the basic unit. The size parameter is used to indicate a change, for example, reducing by half or maintaining, of a size of the feature map obtained through processing by the basic unit.

In an implementation, a neural network in the search space may be a ResNet. In this case, the basic unit is also referred to as a residual unit. The residual unit may include at least two convolutional layers or the like. The residual unit further includes a residual module. The residual module is configured to: add up a feature map input to the residual unit and a feature map obtained by processing, by the residual unit, the feature map input to the residual unit; and input a result of the addition to a next residual unit. In this embodiment of this application, a neural network may be built by coding a residual unit, and the search space is extended through mutation. For a specific implementation, refer to related descriptions of FIG. 7(a) to FIG. 7(f). Details are not described herein again.

In an implementation, a neural network in the search space may be a CNN. In this case, the basic unit is also referred to as a layer structure. The layer structure may be a convolutional layer, a pooling layer, or the like. A neural network may be built through coding, and the search space is extended through mutation. For a specific implementation, refer to related descriptions of FIG. 8(a) to FIG. 8(f). Details are not described herein again.

### Embodiment 3

In an embodiment, for example, in the scenario B shown in FIG. 2B, the neural network search method in embodiments of this application may be applied to the image recognition field. For example, user equipment obtains an image by using a camera, and then may make a decision based on a recognized object in an ambient environment, to achieve safe driving. FIG. 9B shows a gesture recognition method according to this embodiment of this application. The gesture recognition method may be performed by user equipment such as the monitor, the mobile phone, or the smart TV in FIG. 2B or the client device 31 or the user equipment 34 in FIG. 3. The method includes but is not limited to the following steps:

S906: Obtain a to-be-recognized image.

S908: input the to-be-recognized image to a gesture recognition neural network, to obtain a gesture type corresponding to the to-be-recognized image.

Further, user equipment may further perform, based on the gesture type, an operation corresponding to the recognized gesture type. For example, when recognizing a first gesture, the user equipment opens a music player. For another example, when an incoming call is received, if a second gesture is recognized, the user equipment answers the call.

The gesture recognition neural network may be a network determined from a search space by using the neural network search method according to Embodiment 1. In this case, each sample in the dataset in Embodiment 1 includes a sample image and a gesture type corresponding to the sample image.

Same as that in Embodiment 2, the search space in this embodiment of this application is built by using a basic unit and a parameter of the basic unit. The search space is for searching for the object recognition neural network. The parameter of the basic unit includes at least one of a type, a channel quantity parameter, and a size parameter of the basic unit. The basic unit is configured to perform a first operation and a second operation on a feature map input to the basic unit. Herein, the feature map is a feature map of the to-be-recognized image. The first operation is for doubling or maintaining a quantity of feature maps input to the basic unit, the second operation is for changing a size of the feature map input to the basic unit from an original first size to a second size or maintain the first size, and the first size is greater than the second size. For example, the first size is twice the second size. Herein, a size is a side length of the feature map. The channel quantity parameter is used to indicate a change, for example, doubling or maintaining, of a quantity of feature maps obtained through processing by the basic unit. The size parameter is used to indicate a change, for example, reducing by half or maintaining, of a size of the feature map obtained through processing by the basic unit.

In an implementation, a neural network in the search space may be a ResNet. In this case, the basic unit is also referred to as a residual unit. The residual unit may include at least two convolutional layers or the like. The residual unit further includes a residual module. The residual module is configured to: add up a feature map input to the residual unit and a feature map obtained by processing, by the residual unit, the feature map input to the residual unit; and input a result of the addition to a next residual unit. In this embodiment of this application, a neural network may be built by coding a residual unit, and the search space is extended through mutation. For a specific implementation, refer to related descriptions of FIG. 7(a) to FIG. 7(f). Details are not described herein again.

In an implementation, a neural network in the search space may be a CNN. In this case, the basic unit is also referred to as a layer structure. The layer structure may be a convolutional layer, a pooling layer, or the like. A neural network may be built through coding, and the search space is extended through mutation. For a specific implementation, refer to related descriptions of FIG. 8(a) to FIG. 8(f). Details are not described herein again.

It should be noted that for descriptions of scenarios in Embodiment 2 and Embodiment 3, reference may be respectively made to related descriptions of the scenario A and the scenario B. Details are not described herein again.

The following describes, with reference to the scenario A and the scenario B, a model obtained by using the neural network search method in this application.

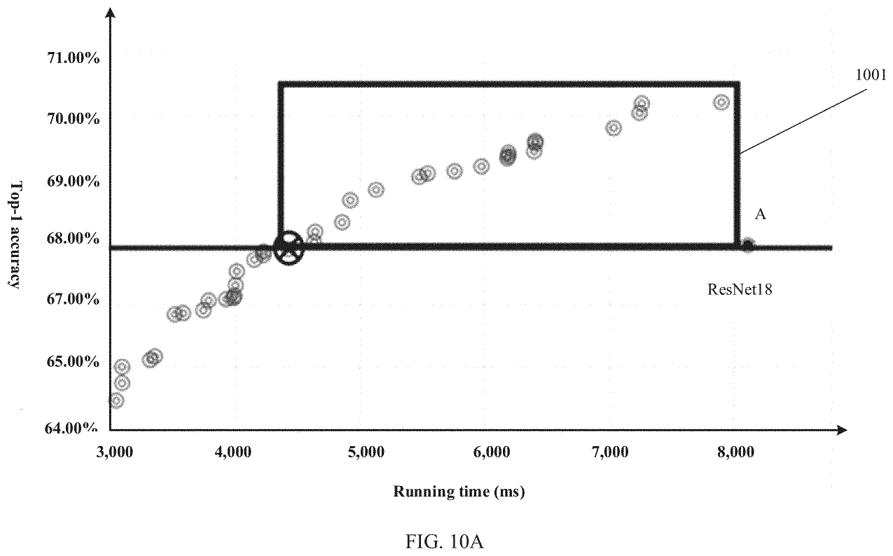

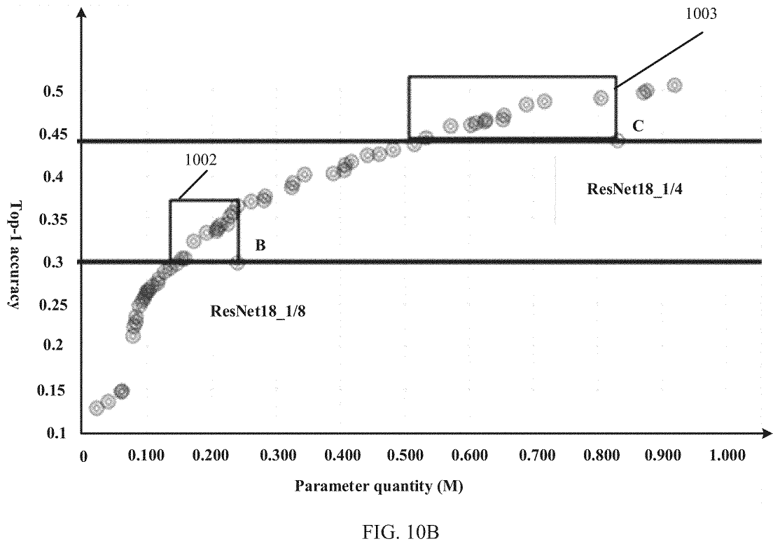

In FIG. 10A, a horizontal axis is a running time of an architecture on a chip platform, and a vertical axis is top-1 accuracy in a dataset (ImageNet). ResNet18 is a running time of an expert model on the chip platform and top-1 accuracy in the dataset (ImageNet) (where the expert model has been trained for 40 epochs). Other points are optimal models found at a same running speed. It can be seen from FIG. 10A that all models in a box 1001 are superior to an existing ResNet18 model in terms of speed and accuracy. Using a leftmost point in the box 1001 as an example, when same accuracy is guaranteed, a speed of a search model this application is 4.42 milliseconds per image, and that in a ResNet is 8.11 milliseconds per image. The speed is as nearly twice faster. Therefore, it can be seen that a search space designed in this application for a hardware platform can actually find an architecture that runs faster and has higher accuracy than the expert model. Table 1 is a table that compares running times, top-1 accuracy, and top-5 accuracy of models obtained after some ResNets in the box 1001 and the expert model ResNet18 undergo complete training by using the dataset (ImageNet).

TABLE 1

| Model name | Running time (ms) | Top-1 | Top-5 |
|---|---|---|---|
| ResNet18 | 8.113 | 69.70 | 89.30 |
| 12-11112-1112 | 4.292 | 69.98 | 89.39 |
| 1-21112-111121 | 4.635 | 70.21 | 89.55 |
| 12-1111-21121 | 4.430 | 70.32 | 89.59 |
| 112-1111-21111112 | 4.644 | 70.45 | 89.68 |
| 12-11121-121 | 5.352 | 70.61 | 89.76 |
| 112-2-1111121 | 4.921 | 70.82 | 89.90 |
| 12-2-11111211 | 5.547 | 71.14 | 90.06 |
| 21-111112-1211 | 6.415 | 71.24 | 90.23 |
| 21-111121-2111 | 7.690 | 72.04 | 90.60 |
| 1211-11112-1111121 | 7.268 | 72.18 | 90.79 |

It can be seen from Table 1 that all models obtained by using the neural network search method in this application are faster and better than ResNet18 after undergoing complete training. A speed of a fastest model is reduced to 4.29 milliseconds per image compared to 8.11 milliseconds per image (with a speed improvement of 48%), and accuracy is further improved by 0.28%. In addition, these models use only common operations such as conv1×1 and conv3×3 (which are available in ResNet18) and do not use special convolutional operations. This is favorable for hard ware.

In FIG. 10B, a horizontal axis is a parameter quantity of a model, and a vertical axis is top-1 accuracy in a dataset (ImageNet). A point B and a point C are respectively expert models ResNet18-¼ and ResNet18-⅛. Other points are models obtained by using the neural network search method in this application. It can be seen from FIG. 10B that all models in a box 1002 are superior to the existing ResNet18-⅛ model in terms of speed and accuracy, and that all models in a box 1003 are superior to the ResNet18-¼ model in terms of speed and accuracy.

It can be seen from the scenario A and the scenario B that the neural network search method provided in embodiments of this application can effectively improve a result of an expert model in different scenarios. This method has specific universality.

The following describes an apparatus and a device in embodiments of this application.

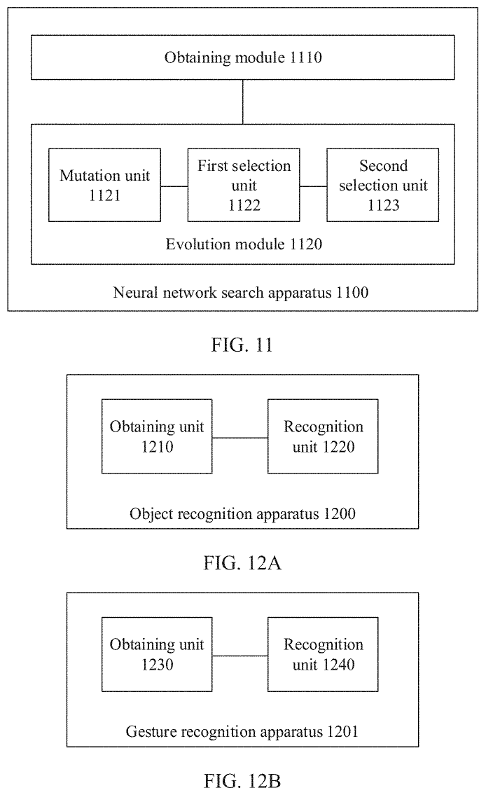

FIG. 11 shows a neural network search apparatus according to an embodiment of this application. The apparatus 1100 may be the computing device 32 in the system shown in FIG. 3. The apparatus 1100 may include but is not limited to the following functional units:

an obtaining module 1110, configured to obtain a dataset and N neural networks, where N is a positive integer; and

an evolution module 1120, configured to perform K evolutions on the N neural networks to obtain a neural network obtained through the K^{th} evolution, where K is a positive integer, and

the evolution module 1120 includes a mutation unit 1121, a first selection unit 1122, and a second selection unit 1123, where

the mutation unit 1121 is configured to: in a process of the evolution, mutate a network structure of a neural network obtained through the (i⁻-1)^{th} evolution, to obtain a mutated neural network;

the first selection unit 1122 is configured to: in the process of the evolution, select, from the mutated neural network, a neural network whose network structure is superior to that of the neural network obtained through the (i−1)^{th} evolution, to obtain a candidate neural network; and

the second selection unit 1123 is configured to: in the process of the evolution, select, from a set of the neural network obtained through the (i−1)^{th} evolution and the candidate neural network and based on P evaluation parameters corresponding to each neural network in the set, a neural network obtained through the i^{th} evolution, where the P evaluation parameters are for evaluating performance of a neural network obtained after each neural network in the set is trained and tested by using the dataset, i and P are positive integers, and 1≤i≤K.

In a possible implementation, the mutation unit 1121 is specifically configured to mutate a first neural network of the neural network obtained through the (i−1)^{th} evolution. When mutating the first neural network of the neural network obtained through the (i−1)^{th} evolution, the mutation unit 1121 performs at least one of the following steps:

swapping locations of two convolutional layers in one or more neural networks of the neural network obtained through the (i−1)^{th} evolution, doubling a channel quantity of one or more convolutional layers in one or more neural networks of the neural network obtained through the (i−1)^{th} evolution;

doubling a step size of a convolution kernel of one or more convolutional layers in one or more neural networks of the neural network obtained through the (i−1)^{th} evolution;

inserting one or more convolutional layers into one or more neural networks of the neural network obtained through the (i−1)^{th} evolution;

deleting one or more convolutional layers from one or more neural networks of the neural network obtained through the (i−1)^{th} evolution;

inserting one or more pooling layers into one or more neural networks of the neural network obtained through the (i−1)^{th} evolution; or deleting one or more pooling layers from one or more neural networks of the neural network obtained through the (i−1)^{th} evolution.

In a possible implementation, the mutation unit 1121 is specifically configured to mutate a first neural network of the neural network obtained through the (i−1)^{th} evolution. When mutating the first neural network of the neural network obtained through the (i−1)^{th} evolution, the mutation unit 1121 performs at least one of the following steps:

swapping locations of two residual units in one or more neural networks of the neural network obtained through the (i−1)^{th} evolution;

doubling a channel quantity of one or more residual units in one or more neural networks of the neural network obtained through the (i−1)^{th} evolution;

doubling a step size of a convolution kernel of one or more residual units in one or more neural networks of the neural network obtained through the (i−1)^{th} evolution;

inserting one or more residual units into one or more neural networks of the neutral network obtained through the (i−1)^{th} evolution; or

deleting one or more residual units from one or more neural networks of the neural network obtained through the (i−1)^{th} evolution.

In a possible implementation, the first selection unit 1122 is specifically configured to: select, from a neural network obtained by mutating the first neural network, a neural network whose network structure is superior to that of the first neural network, where the candidate neural network includes the neural network that is of the neural network obtained by mutating the first neural network and whose network structure is superior to that of the first neural network, and the first neural network is any neural network of the neural network obtained through the (i−1)^{th} evolution.

In a possible implementation, when at least one of the following conditions is met, a network structure of the neural network obtained by mutating the first neural network is superior to the network structure of the first neural network:

a channel quantity of the neural network obtained by mutating the first neural network is greater than a channel quantity of the first neural network; or

a quantity of convolutional layers in the neural network obtained by mutating the first neural network is greater than a quantity of convolutional layers in the first neural network.

In a possible implementation, the second selection unit 1123 is specifically configured to: perform non-dominated sorting on the neural networks in the set based on the P evaluation parameters corresponding to each neural network in the set; and determine that the neural network obtained through the i^{th} evolution is a neural network that is not dominated in the set, where a second neural network and a third neural network are two neural networks in the set, and if the second neural network is not inferior to the third neural network in terms of each of the P evaluation parameters, and the second neural network is superior to the third neural network in terms of at least one of the P evaluation parameters, the second neural network dominates the third neural network.

In a possible implementation, the obtaining module 1110 is specifically configured to: randomly generate M neural networks, where M is a positive integer; train and test each of the M neural networks by using the dataset, to obtain P evaluation parameters corresponding to each of the M neural networks; and select N neural networks from the M neural networks based on the P evaluation parameters corresponding to each of the M neural networks, where N is not greater than M.

In a possible implementation, the P evaluation parameters include at least one of a running time, accuracy, and a parameter quantity.

It should be noted that for specific implementation of each of the foregoing units, refer to related descriptions of the neural network search method according to Embodiment 1. Details are not described herein again.

FIG. 12A shows an object recognition apparatus according to an embodiment of this application. The apparatus 1200 may be the client device 31 or the user equipment 34 in the system shown in FIG. 3. The apparatus 1200 may include but is not limited to the following functional units:

an obtaining unit 1210, configured to obtain a to-be-recognized image, where the to-be-recognized image is an image of an ambient environment of a vehicle; and

a recognition unit 1220, configured to input the to-be-recognized image to an object recognition neural network, to obtain an object type corresponding to the to-be-recognized image.

The object recognition neural network is a network determined from a search space by using the neural network search method according to Embodiment 1, and the search space is built by using a basic unit and a parameter of the basic unit.

Optionally, the parameter of the basic unit includes at least one of a type, a channel quantity parameter, and a size parameter of the basic unit.

Optionally, the basic unit is configured to perform a first operation and a second operation on a feature map input to the basic unit. The feature map is a feature map of the to-be-recognized image, the first operation is for doubling or maintaining a quantity of feature maps input to the basic unit, the second operation is for changing a size of the feature map input to the basic unit from an original first size to a second size or maintain the first size, and the first size is greater than the second size.

It should be noted that for specific implementation of each of the foregoing units, refer to related descriptions of the object recognition method according to Embodiment 2. Details are not described herein again.

FIG. 12B shows a gesture recognition apparatus according to an embodiment of this application. The apparatus 1201 may be the client device 31 or the user equipment 34 in the system shown in FIG. 3. The apparatus 1201 may include but is not limited to the following functional units:

an obtaining unit 1230, configured to obtain a to-be-recognized image; and

a recognition unit 1240, configured to input the to-be-recognized image to a gesture recognition neural network, to obtain a gesture type in the to-be-recognized image.

The gesture recognition neural network is a network determined from a search space by using the neural network search method according to Embodiment 1, and the search space is built by using a basic unit and a parameter of the basic unit.

Optionally, the parameter of the basic unit includes at least one of a type, a channel quantity parameter, and a size parameter of the basic unit.

Optionally, the basic unit is configured to perform a first operation and a second operation on a feature map input to the basic unit. The feature map is a feature map of the to-be-recognized image, the first operation is for doubling or maintaining a quantity of feature maps input to the basic unit, the second operation is for changing a size of the feature map input to the basic unit from an original first size to a second size or maintain the first size, and the first size is greater than the second size. For example, the first size is twice the second size.

It should be noted that for specific implementation of each of the foregoing units, refer to related descriptions of the gesture recognition method according to Embodiment 3. Details are not described herein again.

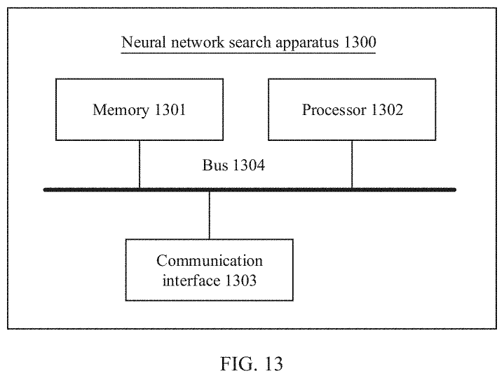

FIG. 13 is a schematic diagram of a hardware structure of a neural network search apparatus according to an embodiment of this application. A neural network training apparatus 1300 (the apparatus 1300 may be specifically a computer device) shown in FIG. 13 may include a memory 1301, a processor 1302, a communication interface 1303, and a bus 1304. Communication connections between the memory 1301, the processor 1302, and the communication interface 1303 are implemented through the bus 1304.

The memory 1301 may be a read-only memory (Read Only Memory, ROM), a static storage device, a dynamic storage device, or a random access memory (Random Access Memory, RAM). The memory 1301 may store a program. When the program stored in the memory 1301 is executed by the processor 1302, the processor 1302 and the communication interface 1303 are configured to perform all or some of the steps in the neural network search method in embodiments of this application.

The processor 1302 may be a general-purpose central processing unit (Central Processing Unit, CPU), a microprocessor, an application-specific integrated circuit (Application Specific Integrated Circuit, ASIC), a graphics processing unit (graphics processing unit, GPU), or one or more integrated circuits, and is configured to: execute a related program, to implement functions that need to be performed by the units in the neural network training apparatus in this embodiment of this application, or perform all or some of the steps in the neural network search method in Method Embodiment 1 of this application.

The processor 1302 may alternatively be an integrated circuit chip and has a signal processing capability. In an implementation process, the steps of the neural network training method in this application may be completed by using a hardware integrated logic circuit in the processor 1302 or instructions in a form of software. The processor 1302 may alternatively be a general-purpose processor, a digital signal processor (Digital Signal Processing, DSP), an application-specific integrated circuit (ASIC), a field programmable gate array (Field Programmable Gate Array, FPGA) or another programmable logic device, a discrete gate or transistor logic device, or a discrete hardware component. The processor may implement or perform the methods, steps, and logical block diagrams that are disclosed in embodiments of this application. The general-purpose processor may be a microprocessor, or the processor may be any conventional processor or the like. The steps in the methods disclosed with reference to embodiments of this application may be directly performed and completed by a hardware decoding processor, or may be performed and completed by using a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the memory 1301. The processor 1302 reads information in the memory 1301, and implements, in combination with hardware of the processor 1302, the functions that need to be performed by the units included in the neural network search apparatus in this embodiment of this application, or performs all or some of the steps in the neural apparatus search method in the method embodiments of this application.

The communication interface 1303 uses, for example, but not limited to, a transceiver-like apparatus, to implement communication between the apparatus 1300 and another device or a communication network. For example, a dataset may be obtained through the communication interface 1303.

The bus 1304 may include a path for information transmission between various components (for example, the memory 1301, the processor 1302, and the communication interface 1303) of the apparatus 1300.

It should be noted that the obtaining module 1110 in the neural network search apparatus 1100 may be equivalent to the communication interface 1303 in the neural network search apparatus 1300, and the evolution module 1120 may be equivalent to the processor 1302.

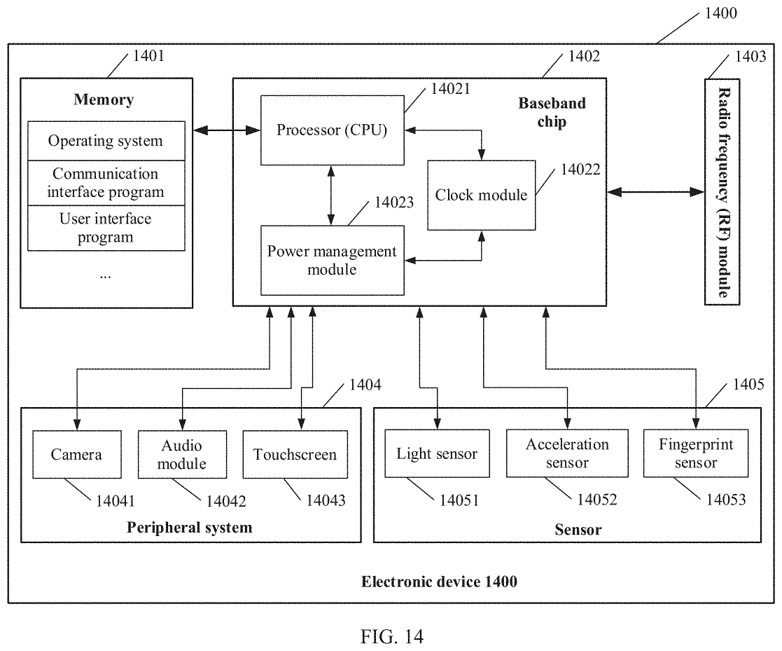

FIG. 14 is a schematic block diagram of an electronic device according to an embodiment of the present invention. The electronic device 1400 (where the apparatus 1400 may be specifically a terminal, a vehicle, a server, or another device) shown in FIG. 14 includes a memory 1401, a baseband chip 1402, a radio frequency module 1403, a peripheral system 1404, and a sensor 1405. The baseband chip 1402 includes at least one processor 14021 such as a CPU, a clock module 14022, and a power management module 14023. The peripheral system 1404 includes a camera 14041, an audio module 14042, a touchscreen 14043, and the like. Further, the sensor 1405 may include a light sensor 14051, an acceleration sensor 14052, a fingerprint sensor 14053, and the like. Modules included in the peripheral system 1404 and the sensor 1405 may be increased or reduced based on an actual requirement. Any two of the foregoing connected modules may be specifically connected through a bus. The bus may be an industry standard architecture (English: industry standard architecture, ISA for short) bus, a peripheral component interconnect (English: peripheral component interconnect, PCI for short) bus, an extended industry standard architecture (English: extended industry standard architecture, EISA for short) bus, or the like.

The radio frequency module 1403 may include an antenna and a transceiver (including a modem). The transceiver is configured to convert an electromagnetic wave received by the antenna into a current, and finally convert the current into a digital signal. Correspondingly, the transceiver is further configured to convert a digital signal to be output by the apparatus 1400 into a current, then convert the current into an electromagnetic wave, and finally transmit the electromagnetic wave to free space by using the antenna. The radio frequency module 1403 may further include at least one amplifier configured to amplify a signal. Generally, the radio frequency module 1403 may be used for wireless transmission, for example, Bluetooth (English: Bluetooth) transmission, wireless-fidelity (English: Wireless-Fidelity, WI-FI for short) transmission, third-generation mobile communication technology (3rd-Generation, 3G for short) transmission, and fourth-generation mobile communication technology (English: the 4th Generation mobile communication, 4G for short) transmission.

The touchscreen 14043 may be configured to display information entered by a user or display information for the user. The touchscreen 14043 may include a touch panel and a display panel. Optionally, the display panel may be configured in a form of a liquid crystal display (English: Liquid Crystal Display, LCD for short), an organic light-emitting diode (English: Organic Light-Emitting Diode. OLED for short), or the like. Further, the touch panel may cover the display panel. When detecting a touch operation on or near the touch panel, the touch panel transmits the touch operation to the processor 14021 to determine a type of a touch event. Then, the processor 14021 provides a corresponding visual output on the display panel based on the type of the touch event. The touch panel and the display panel are used as two independent components to implement input and output functions of the apparatus 1400. However, in some embodiments, the touch panel and the display panel may be integrated to implement the input and output functions of the apparatus 1400.

The camera 14041 is configured to obtain an image, and input the image to an object recognition neural network. It should be understood that, in this case, the object recognition neural network is a deep neural network used to process the image.

The audio input module 14042 may be specifically a microphone, and may obtain a voice. In this embodiment, the apparatus 1400 may convert the voice into a text, and then input the text into a compressed neural network. It should be understood that, in this case, the compressed neural network is a deep neural network used to process the text, for example, a neural network obtained by compressing a text recognition network in a scenario C.

The sensor 1405 may include the light sensor 14051, the acceleration sensor 14052, and the fingerprint sensor 14052. The light sensor 14051 is configured to obtain light intensity of an environment. The acceleration sensor 14052 (such as a gyroscope) may obtain a motion status of the apparatus 1400. The fingerprint sensor 14053 may obtain input fingerprint information. After sensing a related signal, the sensor 1405 quantizes the signal to a digital signal, and transfers the digital signal to the processor 14021 for further processing.

The memory 1401 may be a high-speed RAM memory, or may be a non-volatile memory (non-volatile memory), for example, at least one magnetic disk memory. Optionally, the memory 1401 may further include at least one storage apparatus far away from the processor 14021. The memory 1401 may specifically include an instruction storage area and a data storage area. The instruction storage area may store a program such as an operating system, a user interface program, or a communication interface program. The data storage area may store data required for performing a related operation during the processing, or data generated when the related operation is performed.

As a control center of the apparatus 1400, the processor 14021 connects all parts of the entire mobile phone through various interfaces and lines, and runs the program stored in the memory 1401 and invokes the data stored in the memory 1401 to perform various functions of the apparatus 1400. Optionally, the processor 14021 may include one or more application processors. The application processor mainly processes the operating system, a user interface, an application program, and the like. In this embodiment of this application, the processor 14021 reads information in the memory 1401 to complete, in combination with hardware of the processor 14021, a function that a unit included in the object recognition apparatus 1200 or the gesture recognition apparatus 1201 in embodiments of this application needs to perform, or to perform the object recognition method or the gesture recognition method in the method embodiments of this application.

The radio frequency module 1403 is configured to implement a communication function of the apparatus 1400. Specifically, the apparatus 1400 may receive a target neural network or other data sent by the client device 31 or the computing device 32 in FIG. 3.

For specific implementation of the functional units in FIG. 14, refer to related descriptions in Embodiment 2 or Embodiment 3. Details are not described in this embodiment of this application again.

It should be noted that although only the memory, the processor, and the communication interface of each of the apparatuses 1300 and 1400 shown in FIG. 13 and FIG. 14 are illustrated, in a specific implementation process, a person skilled in the art should understand that the apparatuses 1300 and 1400 each further include other components necessary for normal running. In addition, based on a specific requirement, a person skilled in the art should understand that the apparatuses 1300 and 1400 each may further include hardware components for implementing other additional functions. In addition, a person skilled in the art should understand that the apparatuses 1300 and 1400 each may alternatively include only components required for implementing embodiments of this application, but not necessarily include all the components shown in FIG. 13 or FIG. 14.

It can be understood that the apparatus 1300 is equivalent to the computing device 32 in FIG. 3 or a node in the computing device 32, and the apparatus 1400 is equivalent to the client device 31 or the user equipment 34 in FIG. 3. A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

A person skilled in the art can understand that, the functions described with reference to various illustrative logical blocks, modules, and algorithm steps disclosed and described in this specification can be implemented by using hardware, software, firmware, or any combination thereof. If software is used for implementation, the functions described with reference to the illustrative logical blocks, modules, and steps may be stored in or transmitted over a computer-readable medium as one or more instructions or code and executed by a hardware-based processing unit. The computer-readable medium may include a computer-readable storage medium. The computer-readable storage medium corresponds to a tangible medium such as a data storage medium, or a communication medium including any medium that facilitates transferring of a computer program from one place to another place (for example, according to a communication protocol). In this manner, the computer-readable medium may generally correspond to: (1) a non-transitory tangible computer-readable storage medium, or (2) a communication medium such as a signal or a carrier. The data storage medium may be any usable medium that can be accessed by one or more computers or one or more processors to retrieve instructions, code, and; or data structures for implementing the technologies described in this application. A computer program product may include the computer-readable medium.

By way of example but not limitation, such computer-readable storage medium may include a RAM, a ROM, an EEPROM, a CD-ROM or another optical disc storage apparatus, a magnetic disk storage apparatus or another magnetic storage apparatus, a flash memory, or any other medium that can be used to store desired program code in a form of an instruction or a data structure and that can be accessed by a computer. In addition, any connection is properly referred to as a computer-readable medium. For example, if instructions are transmitted from a website, server, or another remote source through a coaxial cable, an optical fiber, a twisted pair, a digital subscriber line (DSL), or by using wireless technologies such as infrared, radio, and microwave, the coaxial cable, the optical fiber, the twisted pair, the DSL, or the wireless technologies such as infrared, radio, and microwave are included in a definition of the medium. However, it should be understood that the computer-readable storage medium and the data storage medium do not include connections, carriers, signals, or other transitory media, but actually mean non-transitory tangible storage media. Disks and discs used in this specification include a compact disc (CD), a laser disc, an optical disc, a digital versatile disc (DVD), and a Blu-ray disc. The disks usually reproduce data magnetically, whereas the discs reproduce data optically with lasers. Combinations of the foregoing items should also be included in the scope of the computer-readable medium.

Instructions may be executed by one or more processors such as one or more digital signal processors (DSP), general-purpose microprocessors, application-specific integrated circuits (ASIC), field programmable gate arrays (FPGA), or other equivalent integrated circuits or discrete logic circuits. Therefore, the term “processor” used in this specification may refer to the foregoing structure, or any other structure suitable for implementing the technologies described in this specification. In addition, in some aspects, the functions described with reference to the illustrative logical blocks, modules, and steps described in this specification may be provided within dedicated hardware and/or software modules configured for encoding and decoding, or may be incorporated into a combined codec. In addition, the technologies may be all implemented in one or more circuits or logic elements.

The technologies in this application may be implemented in various apparatuses or devices, including a wireless handset, an integrated circuit (IC), or a set of ICs (for example, a chip set). Various components, modules, or units are described in this application to emphasize functional aspects of the apparatuses configured to perform the disclosed technologies, but are not necessarily implemented by using different hardware units. Actually, as described above, various units may be combined into a codec hardware unit in combination with appropriate software and/or firmware, or may be provided by interoperable hardware units (including the one or more processors described above).

The foregoing descriptions are merely specific example implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A neural network search method, comprising:
obtaining, by a computing device, a dataset and N neural networks, wherein N is a positive integer; and
performing, by the computing device, K evolutions on the N neural networks to obtain a neural network obtained through the K^{th} evolution, wherein K is a positive integer; and
the i^{th} evolution comprises:
mutating, by the computing device, a network structure of a neural network obtained through the (i−1)^{th} evolution, to obtain a mutated neural network;
selecting, by the computing device from the mutated neural network, a neural network whose network structure is superior to that of the neural network obtained through the (i−1)^{th} evolution, to obtain a candidate neural network; and
selecting, by the computing device from a se of the neural network obtained through the (i−1)^{th} evolution and the candidate neural network and based on P evaluation parameters corresponding to each neural network in the set, a neural network obtained through the i^{th} evolution, wherein the P evaluation parameters are for evaluating performance of a neural network obtained after each neural network in the set is trained and tested by using the dataset, i and P are positive integers, and 1≤i≤K.

2. The method according to claim 1, wherein the mutating, by the computing device, a network structure of a neural network obtained through the (i−1)^{th} evolution comprises at least one of the following steps:
swapping locations of two convolutional layers in one or more neural networks of the neural network obtained through the (i−1)^{th} evolution;
doubling a channel quantity of one or more convolutional layers in one or more neural networks of the neural network obtained through the (i−1)^{th} evolution;
doubling a step size of a convolution kernel of one or more convolutional layers in one or more neural networks of the neural network obtained through the (i−1)^{th} evolution;
inserting one or more convolutional layers into one or more neural networks of the neural network obtained through the (i−1)^{th} evolution;
deleting one or more convolutional layers from one or more neural networks of the neural network obtained through the (i−1)^{th} evolution;
inserting one or more pooling layers into one or more neural networks of the neural network obtained through the (i−1)^{th} evolution; or
deleting one or more pooling layers from one or more neural networks of the neural network obtained through the (i−1)^{th} evolution.

3. The method according to claim 1, wherein the neural network obtained through the (i−1)^{th} evolution is a deep residual network, and the mutating, by the computing device, a network structure of a neural network obtained through the (i−1)^{th} evolution comprises at least one of the following steps:
swapping locations of two residual units in one or more neural networks of the neural network obtained through the (i−1)^{th} evolution;
doubling a channel quantity of one or more residual units in one or more neural networks of the neural network obtained through the (i−1)^{th} evolution;
doubling a step size of a convolution kernel of one or more residual units in one or more neural networks of the neural network obtained through the (i−1)^{th} evolution;
inserting one or more residual units into one or more neural networks of the neural network obtained through the (i−1)^{th} evolution; or
deleting one or more residual units from one or more neural networks of the neural network obtained through the (i−1)^{th} evolution.

4. The method according to claim 1, wherein the selecting, by the computing device from the mutated neural network, a neural network whose network structure is superior to that of the neural network obtained through the (i−1)^{th} evolution, to obtain a candidate neural network comprises:
selecting, by the computing device from a neural network obtained by mutating a first neural network, a neural network whose network structure is superior to that of the first neural network, wherein the candidate neural network comprises the neural network that is of the neural network obtained by mutating the first neural network and whose network structure is superior to that of the first neural network, and the first neural network is any neural network of the neural network obtained through the (i−1)^{th} evolution.

5. The method according to claim 4, wherein when at least one of the following conditions is met, a network structure of the neural network obtained by mutating the first neural network is superior to the network structure of the first neural network:
a channel quantity of the neural network obtained by mutating the first neural network is greater than a channel quantity of the first neural network; or
a quantity of convolutional layers in the neural network obtained by mutating the first neural network is greater than a quantity of convolutional layers in the first neural network.

6. The method according to claim 1, wherein the selecting, by the computing device from a set of the neural network obtained through the (i−1)^{th} evolution and the candidate neural network and based on P evaluation parameters corresponding to each neural network in the set, a neural network obtained through the i^{th} evolution specifically comprises:
performing, by the computing device, non-dominated sorting on the neural networks in the set based on the P evaluation parameters corresponding to each neural network in the set; and
determining, by the computing device, that the neural network obtained through the in evolution is a neural network that is not dominated in the set, wherein
a second neural network and a third neural network are two neural networks in the set, and if the second neural network is not inferior to the third neural network in terms of each of the P evaluation parameters, and the second neural network is superior to the third neural network in terms of at least one of the P evaluation parameters, the second neural network dominates the third neural network.

7. The method according to claim 1, wherein the obtaining, by a computing device, N neural networks specifically comprises:
randomly generating, by the computing device, neural networks, wherein M is a positive integer;
training and testing, by the computing device, each of the M neural networks by using the dataset, to obtain P evaluation parameters corresponding to each of the M neural networks; and
selecting, by the computing device, N neural networks from the M neural networks based on the P evaluation parameters corresponding to each of the M neural networks, wherein N is not greater than M.

8. The method according to claim 1, wherein the P evaluation parameters comprise at least one of a running time, accuracy, and a parameter quantity.

9. A neural network search apparatus, comprising:
an obtaining module, configured to obtain a dataset and N neural networks, wherein N is a positive integer; and
an evolution module, configured to perform K evolutions on the N neural networks to obtain a neural network obtained through the K^{th} evolution, wherein K is a positive integer; and
the evolution module comprises a mutation unit, a first selection unit, and a second selection unit, wherein
the mutation unit is configured to: in a process of the evolution, mutate a network structure of a neural network obtained through the (i−1)^{th} evolution, to obtain a mutated neural network, wherein a neural network obtained through the 0^{th} evolution is the N neural networks;
the first selection unit is configured to: in the process of the i^{th} evolution, select, from the mutated neural network, a neural network whose network structure is superior to that of the neural network obtained through the (i−1)^{th} evolution, to obtain a candidate neural network; and
the second selection unit is configured to: in the process of the evolution, select, from a set of the neural network obtained through the (i−1)^{th} evolution and the candidate neural network and based on P evaluation parameters corresponding to each neural network in the set, a neural network obtained through the i^{th} evolution, wherein the P evaluation parameters are for evaluating performance of a neural network obtained after each neural network in the set is trained and tested by using the dataset, i and P are positive integers, and 1≤i≤K.

10. The apparatus according to claim 9, wherein the mutation unit is specifically configured to perform at least one of the following steps:
swapping locations of two convolutional layers in one or more neural networks of the neural network obtained through the (i−1)^{th} evolution;
doubling a channel quantity of one or more convolutional layers in one or more neural networks of the neural network obtained through the)^{th} evolution;
doubling a step size of a convolution kernel of one or more convolutional layers in one or more neural networks of the neural network obtained through the (i−1)^{th} evolution;
inserting one or more convolutional layers into one or more neural networks of the neural network obtained through the (i−1)^{th} evolution;
deleting one or more convolutional layers from one or more neural networks of the neural network obtained through the (i−1)^{th} evolution;
inserting one or more pooling layers into one or more neural networks of the neural network obtained through the (i−1)^{th} evolution; or
deleting one or more pooling layers from one or more neural networks of the neural network obtained through the (i−1)^{th} evolution.

11. The apparatus according to claim 9, wherein the neural network obtained through the (i−1)^{th} evolution is a deep residual network, and the mutation unit is specifically configured to perform at least one of the following steps:
swapping locations of two residual units in one or more neural networks of the neural network obtained through the (i−1)^{th} evolution;
doubling a channel quantity of one or more residual units in one or more neural networks of the neural network obtained through the (i−1)^{th} evolution;
doubling a step size of a convolution kernel of one or more residual units in one or more neural networks of the neural network obtained through the (i−1)^{th} evolution;
inserting one or more residual units into one or more neural networks of the neural network obtained through the (i−1)^{th} evolution; or
deleting one or more residual units from one or more neural networks of the neural network obtained through the (i−1)^{th} evolution.

12. The apparatus according to claim 9, wherein the first selection unit is specifically configured to:
select, from a neural network obtained by mutating a first neural network, a neural network whose network structure is superior to that of the first neural network, wherein the candidate neural network comprises the neural network that is of the neural network obtained by mutating the first neural network and whose network structure is superior to that of the first neural network, and the first neural network is any neural network of the neural network obtained through the (i−1)^{th} evolution.

13. The apparatus according to claim 12, wherein when at least one of the following conditions is met, a network structure of the neural network obtained by mutating the first neural network is superior to the network structure of the first neural network:
a channel quantity of the neural network obtained by mutating the first neural network is greater than a channel quantity of the first neural network; or
a quantity of convolutional layers in the neural network obtained by mutating the first neural network is greater than a quantity of convolutional layers in the first neural network.

14. The apparatus according to claim 9, wherein the second selection unit is specifically configured to:
perform non-dominated sorting on the neural networks in the set based on the P evaluation parameters corresponding to each neural network in the se; and
determine that the neural network obtained through the (i−1)^{th} evolution is a neural network that is not dominated in the set, wherein
a second neural network and a third neural network are two neural networks in the set, and if the second neural network is not inferior to the third neural network in terms of each of the P evaluation parameters, and the second neural network is superior to the third neural network in terms of at least one of the P evaluation parameters, the second neural network dominates the third neural network.

15. The apparatus according to claim 9, wherein the obtaining module is specifically configured to:
randomly generate M neural networks, wherein M is a positive integer;
train and test each of the M neural networks by using the dataset, to obtain P evaluation parameters corresponding to each of the M neural networks; and
select N neural networks from the M neural networks based on the P evaluation parameters corresponding to each of the M neural networks, wherein N is not greater than M.

16. The apparatus according to claim 9, wherein the P evaluation parameters comprise at least one of a running time, accuracy, and a parameter quantity.

17. A neural network search apparatus, comprising a processor and a memory, wherein the memory is configured to store a program, the processor executes the program stored in the memory, and when the program stored in the memory is executed, the neural network search apparatus is enabled to implement the method according to claim 1.

18. A computer-readable storage medium, wherein the computer-readable medium is configured to store computer-executable instructions, and when being invoked by a computer, the computer-executable instructions are used to enable the computer to implement the method according to claim 1.

19. An object recognition method, comprising:
obtaining a to-be-recognized image; and
inputting the to-be-recognized image to an object recognition neural network, to obtain an object type corresponding to the to-be-recognized image, wherein
the object recognition neural network is a network determined from a search space by using the neural network search method according to claim 1, and the search space is built by using a basic unit and a parameter of the basic unit.

20. The method according to claim 19, wherein the parameter of the basic unit comprises at least one of a type, a channel quantity parameter, and a size parameter of the basic unit.

21. The method according to claim 19, wherein the basic unit is configured to perform a first operation and a second operation on a feature map input to the basic unit; the feature map is a feature map of the to-be-recognized image, the first operation is for doubling or maintaining a quantity of feature maps input to the basic unit, the second operation is for changing a size of the feature map input to the basic unit from an original first size to a second size or maintain the first size, and the first size is greater than the second size.

22. An object recognition apparatus, comprising a processor and a memory, wherein the memory is configured to store a program, the processor executes the program stored in the memory, and when the program stored in the memory is executed, the object recognition apparatus is enabled to implement the method according to claim 19.
